(19) United States
(12) Patent Application Publication
(10) Pub. No.: US 2014/0073706 A1
(43) Pub. Date: Mar. 13, 2014

(54) Method for Obtaining an Emulsion Containing an Internal Hydrophobic Phase Dispersed in a Continuous Hydrophilic Phase

(71) Applicants: Isabelle Capron, Nantes (FR); Bernard Cathala, La Chapelle sur Erdre (FR); Hervé Bizot, Suce-sur-Erdre (FR)

(72) Inventors: Isabelle Capron, Nantes (FR); Bernard Cathala, La Chapelle sur Erdre (FR); Hervé Bizot, Suce-sur-Erdre (FR)

(73) Assignee: INSTITUT NATIONAL DE LA RECHERCHE AGRONOMIQUE

(21) Appl. No.: 14/110,414

(22) PCT Filed: Apr. 20, 2012
(86) PCT No.: PCT/FR12/50874

§ 371 Date: Nov. 25, 2013

(30) Foreign Application Priority Data
Apr. 20, 2011 (FR) 1153436

(51) Int. Cl. B01F 17/00

(52) U.S. Cl. CPC B01F 17/0028
USPC 514/781; 252/62

(57) ABSTRACT

The invention relates to a method for producing an emulsion including a hydrophobic internal phase dispersed in a hydrophilic continuous phase, of the medium internal phase (MIPE) or high internal phase (HIPE) type, which has an internal phase percentage higher than 55%, comprising the following steps:
a) producing an oil-in-water emulsion composition that has a hydrophobic phase/hydrophilic phase volume ratio of at least 5/95, including a step for incorporating cellulose nanocrystals into said hydrophilic phase, and a step for forming the emulsion by dispersing said hydrophobic phase in said hydrophilic phase, and
b) producing an emulsion that has an internal phase percentage higher than 55%, including:
b.1) a step for adding a volume of hydrophobic phase to the emulsion composition produced in Step a), and stirring the mixture thereby produced, and/or
b.2) a step for concentrating the emulsion composition produced in Step a), by removing at least part of said hydrophilic phase.

### SCOPE OF THE INVENTION

The present invention relates to the area of manufacturing elevated internal phase emulsions, referred to as “medium internal phase” or “high internal phase” emulsions, also referred to as “MIPE” or “HIPE” emulsions, as well as to their various industrial applications, specifically for the preparation of polymer supports, foams, or materials.

### PRIOR ART

An emulsion is a macroscopically homogeneous but microscopically heterogeneous mixture of two nonmiscible liquid substances.

The two liquid substances involved are referred to as phases. One phase is continuous; the other internal discontinuous phase is dispersed in the first phase in the form of droplets.

Certain specific emulsions consist of liquid/liquid immiscible dispersed systems wherein the volume of the internal phase, also referred to as the dispersed phase, occupies a volume that is higher than approximately 50 percent of the emulsion's total volume.

Such elevated internal phase emulsions traditionally consist of so-called “medium internal phase” emulsions (MIPEs) or “high internal phase” emulsions (HIPEs).

High internal phase emulsions, or HIPEs, consist of liquid/liquid immiscible dispersed systems wherein the volume of the internal phase, also referred to as the dispersed phase, occupies a volume that is higher than approximately 74-75 percent of the emulsion's total volume; that is, a higher volume than what is geometrically possible for the close packing of monodisperse spheres.

Water-in-oil and oil-in-water high internal phase emulsions are known.

Each of the two above cited types may be used for the preparation of porous polymer materials or polymer particles.

The production of water-in-oil HIPE emulsions and their use for the manufacture of polymer foams are described, e.g., in PCT Patent Application No. WO 2009/013500 or in PCT Patent Application No. WO 2010/058148.

The production of oil-in-water HIPE emulsions and their use for the manufacture of polymer foams is described, e.g., in U.S. Pat. No. 6,218,440.

U.S. Pat. No. 6,218,440, describes the preparation of hydrophilic microbeads using a method that includes a step for producing an oil-in-water HIPE emulsion, whose aqueous continuous phase includes a hydrophilic monomer, then a step wherein the produced HIPE emulsion is added to an oily suspension under a nitrogen stream, followed by a step wherein said hydrophilic monomer is polymerized into microbeads, prior to precipitation and drying of the produced microbeads. Various emulsifiers and stabilizers are used in the formation of a HIPE emulsion according to this U.S. patent.

For their part, medium internal phase emulsions or MIPEs consist of liquid/liquid immiscible dispersed systems wherein the volume of the internal phase occupies a volume ranging from approximately 50 to 74-75 percent of the emulsion's total volume.

These medium internal phase emulsions may also be used for the preparation of porous polymer materials or polymer particles.

The production of water-in-oil MIPE emulsions and their use for the manufacture of polymer foams is described, e.g., in the above-cited PCT Patent Application No. WO 2010/058148.

Nevertheless, a need continues to exist in the art for alternative or improved methods for producing oil-in-water MIPE or HIPE emulsions, for various industrial applications.

Specifically, a need exists for elevated internal phase emulsions stabilized by agents that are available in large quantities, biodegradable, nontoxic, renewable, inexpensive, low-density, and easily adaptable through surface modification.

### SUMMARY OF THE INVENTION

The present invention relates to a method for producing an elevated internal phase oil-in-water emulsion, of the medium internal phase (MIPE) or high internal phase (HIPE) type, starting with a Pickering-type oil-in-water emulsion stabilized by cellulose nanocrystals.

Specifically, the present invention relates to a method for producing an emulsion including a hydrophobic internal phase dispersed in a hydrophilic continuous phase, of the medium internal phase (MIPE) or high internal phase (HIPE) type, which has an internal phase percentage higher than 55%, comprising the following steps:

a) producing an oil-in-water emulsion composition that has a hydrophobic phase/hydrophilic phase volume ratio of at least 5/95, including a step for incorporating cellulose nanocrystals into said hydrophilic phase, and a step for forming the emulsion by dispersing said hydrophobic phase in said hydrophilic phase, and

b) producing an emulsion that has an internal phase percentage higher than 55%, including:

b.1) a step for adding a volume of hydrophobic phase to the emulsion composition produced in Step a), and stirring the mixture thereby produced, and/or

b.2) a step for concentrating the emulsion composition produced in Step a), by removing at least part of said hydrophilic phase.

Following Step b), the formed emulsion is advantageously a medium internal phase emulsion (MIPE) having an internal phase percentage ranging from 55% to 75%; alternatively, following Step b), the formed emulsion is advantageously a high internal phase emulsion (HIPE) having an internal phase percentage higher than 75%.

In Step a), the emulsion composition advantageously has an internal phase percentage that is lower than or equal to 55%.

In certain embodiments, the emulsion prepared in Step b) includes a hydrophobic internal phase/hydrophilic continuous phase volume ratio of at least 60/40.

According to another specific feature, in Step a), the emulsion composition advantageously has a hydrophobic phase/hydrophilic phase volume ratio of at most 60/40.

Additionally according to a specific feature, the emulsion prepared in Step b) advantageously includes a hydrophobic internal phase/hydrophilic continuous phase volume ratio of at least 80/20.

Again according to a specific feature, the hydrophobic phase advantageously includes a hydrophobic liquid or a mixture of hydrophobic liquids.

In this case, the hydrophobic liquids advantageously include alkanes selected from linear alkanes, branched alkanes, cyclic alkanes, and the mixture of at least two of said alkanes, with said alkane having a number of carbon atoms ranging from 5 to 18 carbon atoms.

The alkane is preferably selected from hexadecane and cyclohexane.

Again in this case, the hydrophobic liquids advantageously include edible oils, such as soybean oil or sunflower oil.

Again according to a specific feature, the hydrophilic phase advantageously includes a hydrophilic monomer or a mixture of hydrophilic monomers.

The present invention also relates to an emulsion composition including a hydrophobic internal phase dispersed in a hydrophilic continuous phase, of the medium internal phase (MIPE) or high internal phase (HIPE) type, with said composition including cellulose nanocrystals located at the interface between the hydrophobic phase and the hydrophilic phase, and with said composition having an internal phase percentage higher than 55%, preferably from 55% to 75% for MIPEs or over 75% for HIPEs.

### DESCRIPTION OF THE FIGURES

FIG. 1 illustrates the hydrophobic internal phase percentage measurement results (internal phase volume percentage) for a series of emulsion compositions stabilized by cellulose nanocrystals, with said compositions being prepared via dispersion of the hydrophobic phase with decreasing hydrophilic phase/hydrophobic phase ratios. Y axis: percentage of hydrophobic dispersed phase volume in relation to the total volume of the emulsion composition. X axis: values of the hydrophilic phase/hydrophobic phase volume ratio for each tested emulsion composition.

FIG. 2 illustrates, for HIPE emulsions prepared according to the method of the invention, the variation of the hydrophobic dispersed phase volume percentage in the emulsion (or “internal phase percentage”) based on the added hydrophobic phase volume, when this internal phase is exclusively hexadecane. Curve 1: theoretical curve. Curve 2: experimental results with a cyclohexane hydrophobic phase Pickering emulsion. Curve 3: experimental results with a hexadecane hydrophobic phase Pickering emulsion. X axis: added hexadecane hydrophobic phase, expressed in mL. Y axis: hydrophobic dispersed phase volume percentage (hexadecane) in relation to the total volume of the HIPE emulsion composition.

FIG. 3 illustrates, for HIPE emulsions prepared according to the method of the invention, the variation of the hydrophobic dispersed phase volume percentage in the emulsion (or “internal phase percentage”) based on the added hydrophobic phase volume. Curve 1: experimental results with a cyclohexane hydrophobic phase. Curve 2: experimental results with a hydrophobic hexadecane phase. X axis: hydrophobic phase added volume, expressed in mL. Y axis: hydrophobic dispersed phase volume percentage in relation to the total volume of the emulsion composition.

FIG. 4 illustrates confocal laser scanning microscopy (CLSM) shots of two emulsions, respectively (i) an oil-in-water emulsion stabilized by cellulose nanocrystals used as a starting material in the method of the invention, at two distinct magnifications (FIGS. 4A, 4B) and (ii) an oil-in-water HIPE emulsion according to the invention having an 80% internal phase percentage, at two distinct magnifications (FIGS. 4C, 4D). The fluorescence signal is generated by the BODIPY marker (™, 4,4-difluoro-4-bora-3a,4a-diaza-s-indacene) that is located inside the oil, near the oil/water interface. It delimits the hydrophobic internal phase/hydrophilic continuous phase interface and tracks its deformation.

FIG. 5 illustrates scanning electron microscopy (SEM) shots of a foam obtained via lyophilization (i) either of a Pickering emulsion (FIGS. 5A and 5B), (ii) or of a HIPE emulsion (FIGS. 5C and 5D) according to the invention with a cyclohexane hydrophobic dispersed phase; FIG. 5A: magnification×430. FIG. 5B: magnification×6000. 5C: magnification×1000. FIG. 5D: magnification×5500.

FIG. 6 consists of two phase diagrams for HIPE emulsions stabilized by cotton nanocrystals at 0.16 e/nm² (FIG. 6A) and at 0.016 e/nm² (FIG. 6B), based on a variation in the concentration of said nanocrystals in the aqueous phase and on a variation in salinity. X axis: molarity in NaCl, expressed in M. Y axis: cellulose nanocrystal concentration expressed in g/L. A: stable emulsion absent; B: emulsion of unstructured gel, then an increasingly structured gel; C: liquid gel; D: viscous gel; E: viscoelastic gel; F: solid gel.

### DETAILED DESCRIPTION OF THE INVENTION

The present invention provides a novel method for preparing elevated internal phase emulsion compositions; that is, medium internal phase (MIPE) or high internal phase (HIPE) emulsions.

These compositions include a hydrophobic internal phase dispersed in a hydrophilic continuous phase; that is, oil-in-water MIPE emulsions or oil-in-water HIPE emulsions.

An “elevated internal phase emulsion” is a liquid/liquid immiscible dispersed system wherein the internal phase volume, also referred to as the dispersed phase, occupies a volume higher than 50, preferably approximately 55, percent of the emulsion's total volume.

By way of reminder, a high internal phase emulsion (HIPE) consists of a liquid/liquid immiscible dispersed system wherein the internal phase volume, also referred to as the dispersed phase, occupies a volume higher than approximately 74-75 percent of the emulsion's total volume; that is, a volume higher than what is geometrically possible for close packing of monodisperse spheres; that is, a population of spheres that are of homogeneous size.

Also by way of reminder, a medium internal phase emulsion (MIPE) consists of a liquid/liquid immiscible dispersed system wherein the internal phase occupies a volume ranging from 50 to 74-75 percent of the emulsion's total volume.

According to the invention, the medium internal phase emulsion (MIPE) consists advantageously of a liquid/liquid immiscible dispersed system wherein the internal phase occupies a volume ranging from 55 to 74-75 percent of the emulsion's total volume.

Specifically, the invention relates to a method for producing an oil-in-water HIPE emulsion including a step for adding an appropriate volume of hydrophobic phase to an oil-in-water Pickering emulsion stabilized by cellulose nanocrystals.

The invention therefore involves a method for producing an oil-in-water MIPE or HIPE emulsion, having an internal phase percentage higher than 55%, comprising the following steps:

a) producing an oil-in-water emulsion composition that has a hydrophobic phase/hydrophilic phase volume ratio of at least 5/95, including a step for incorporating cellulose nanocrystals into said hydrophilic phase, and a step for forming the emulsion by dispersing said hydrophobic phase in said hydrophilic phase, and

b) producing an emulsion that has an internal phase percentage higher than 55%, including:

b.1) a step for adding a hydrophobic phase volume to the emulsion composition produced in Step a), and stirring the mixture thereby produced, and/or

b.2) a step for concentrating the emulsion composition produced in Step a), by removing at least part of said hydrophilic phase.

By “emulsion,” we mean a macroscopically homogeneous but microscopically heterogeneous mixture of two nonmiscible liquid phases.

In an “oil-in-water” emulsion, as specified by the invention, (i) the hydrophilic dispersing continuous phase consists of an aqueous phase and (ii) the dispersed internal phase is a hydrophobic phase.

An oil-in-water emulsion may also be designated by the letters “O/W” in the present description.

In the present description, the terms “oily phase” and “hydrophobic phase” may be used interchangeably to designate the oily liquid used for the preparation of an oil-in-water emulsion.

In the present description, the terms “aqueous phase” and “hydrophilic phase” may be used interchangeably to designate the aqueous liquid used for the preparation of an oil-in-water emulsion.

In the present description, the terms “internal phase,” “hydrophobic internal phase,” “dispersed phase,” “hydrophobic dispersed phase” may be used interchangeably to designate the dispersed oily phase of an oil-in-water emulsion.

In the present description, the terms “continuous phase,” “hydrophilic continuous phase,” and “aqueous continuous phase” may be used interchangeably to designate the dispersing aqueous phase of an oil-in-water emulsion.

By “internal phase percentage” of an emulsion composition, we mean, according to the invention, the ratio between (i) the hydrophobic phase volume dispersed in the hydrophilic continuous phase and (ii) the total volume of the resulting emulsion, expressed as a volume percentage.

In certain situations, when an elevated internal phase emulsion—specifically, a HIPE emulsion—is prepared in accordance with the method defined above, one may produce an emulsion phase including the hydrophobic phase that is dispersed in the hydrophilic continuous phase in the form of an emulsion, if necessary with (i) an oily phase constituted of a volume of the hydrophobic phase that is present in the composition in a nondispersed form (with this volume being measured) and/or (ii) an aqueous phase (not part of the emulsion).

The internal phase percentage is calculated by (i) measuring the volume of the nondispersed hydrophobic phase, which generally exceeds the emulsion phase, (ii) measuring the volume of the emulsion phase, then (iii) calculating the volume of the hydrophobic phase, which is in dispersed form inside the emulsion phase, with the understanding that the total hydrophobic phase volume contained in the composition is known.

By “hydrophobic internal phase/hydrophilic continuous phase volume ratio,” specifically for a MIPE or HIPE emulsion, we mean, according to the invention, the ratio between (i) the volume of the hydrophobic phase integrated into the emulsion, and (ii) the volume of the hydrophilic phase integrated into the emulsion.

The latter ratio is exclusively indicative, in the sense that it also depends upon the quantity of cellulose nanocrystals integrated into the emulsion. In general, trials were conducted with a hydrophilic phase containing cellulose nanocrystals in suspension at a concentration of 5 g/L. This concentration is in no way limiting; the most reliable limit is advantageously, without being in any way limited to, a recovery rate of 60% while the Pickering emulsion is being manufactured. If the stability condition for the Pickering emulsion is met (Step a)), the method may be continued by adding the hydrophobic phase in order to form the elevated internal phase emulsion, specifically the HIPE emulsion (Step b)).

The applicant has unexpectedly shown that oil-in-water MIPE or HIPE emulsions that have a high hydrophobic dispersed phase content, higher than 55% or even 75% of the emulsion's total volume, may be produced from Pickering-type emulsions stabilized by cellulose nanocrystals.

Pickering-type emulsions are known in the art. Pickering emulsions are emulsions that are stabilized by particles in colloidal suspension located at the oil/water interface.

In general, Pickering emulsions do not contain conventional surfactants. In certain embodiments, a Pickering emulsion may contain one or several conventional surfactants, but in insufficient quantities to stabilize an emulsion.

The Pickering emulsion compositions stabilized by cellulose nanocrystals that are used as starting materials for producing the oil-in-water MIPE or HIPE emulsions disclosed in the description, are specific to the present invention and their method of preparation is specified in detail herein below.

More specifically, the applicant has shown that, in unexpected fashion, MIPE or HIPE emulsions of the above cited type may be produced when an oil-in-water Pickering emulsion stabilized with cellulose nanocrystals is used as a starting composition.

In particular, we have shown, according to the invention, that HIPE emulsions are produced because Pickering emulsion compositions stabilized with cellulose nanocrystals make it possible, while Step b) is under way, to skip the close packing stage of the hydrophobic internal phase droplets; that is, to obtain an internal phase percentage higher than 75%.

The present invention also relates to a method for producing an emulsion including a hydrophobic internal phase dispersed in a hydrophilic continuous phase, of the medium internal phase (MIPE) or high internal phase (HIPE) type, comprising the following steps:

a) producing a Pickering oil-in-water emulsion composition including a hydrophobic phase and a hydrophilic phase, with a hydrophobic phase/hydrophilic phase volume ratio of at least 5/95, including a step for incorporating cellulose nanocrystals into said hydrophilic phase, and a step for forming the emulsion by dispersing said hydrophobic phase in said hydrophilic phase, and

b) producing an emulsion that has an internal phase percentage higher than 55%, if necessary of the MIPE or HIPE type, including:

b.1) a step for adding a hydrophobic phase volume to the emulsion composition produced in Step a), and stirring the mixture thereby produced, and/or

b.2) a step for concentrating the emulsion composition produced in Step a), by removing at least part of said hydrophilic phase.

In Step a) of a method for producing a Pickering oil-in-water emulsion according to the invention, the hydrophobic phase/hydrophilic phase volume ratio is advantageously at least 5/95, and preferably at most 50/50, and even at most 60/40.

By “at least 5/95,” we mean a minimum value of 5 for the hydrophobic phase in the volume ratio.

By “at most 50/50,” or “at most 60/40,” we mean the maximum value of 50 or 60, respectively, for the hydrophobic phase in the volume ratio.

In this context, the hydrophobic phase/hydrophilic phase volume ratio is advantageously selected from 5/95, 10/90, 15/85, 20/80, 25/75, 30/70, 35/65, 40/60, 45/55, 50/50, 55/45, or 60/40.

This Pickering oil-in-water emulsion of the invention advantageously has an internal phase percentage that is lower than or equal to 55%.

According to one embodiment, in Step b) of a method for producing a HIPE oil-in-water emulsion of the invention, the added dispersed hydrophobic phase volume is added to the above cited emulsion produced in Step a).

We have shown in the examples that the method for producing HIPE emulsions of the invention enables preparation of emulsions with a high hydrophobic internal phase content, having up to more than 95% by volume of hydrophobic internal phase in relation to the emulsion's total volume.

We have also shown that HIPE emulsions prepared according to the method of the invention and having a hydrophobic internal phase/hydrophilic dispersed phase volume ratio higher than 78/22 may take the form of a gel.

We have shown in the examples that HIPE emulsion compositions prepared using the method of the invention are stable over a long period of time, including when they are stored at a temperature of approximately 20° C.

Moreover, we have shown that HIPE emulsions produced in accordance with the method of the invention offer excellent compression strength. By way of illustration, a HIPE emulsion of the invention having an 85% internal phase percentage is not broken when it undergoes centrifugal force up to 10000 g, even 16000 g.

Additionally, the applicant has shown that rupture of a HIPE emulsion of the invention is reversible, e.g., rupture caused by shear (for example, due to vigorous stirring) or compression (for example, due to intense centrifugation). A HIPE emulsion of the invention therefore offers the property of being able to reform itself after a rupture. By way of illustration, we have shown that a HIPE emulsion of the invention having an internal phase percentage of 75%, which was broken due to centrifugation or manual stirring, can be regenerated simply through stirring, e.g., using a traditional stirring device, such as a known rotor-stator apparatus, e.g., a device marketed under the name Ultraturrax™. It should be noted that the ability of a HIPE emulsion of the invention to be regenerated following rupture is not influenced by the type of cellulose nanocrystals used, and in particular is not influenced by the hydrophilia/hydrophobicity level of said nanocrystals.

By studying HIPE emulsions of the invention using confocal laser scanning microscopy, we observed that the oil droplets dispersed in the aqueous continuous phase are deformed with increasing hydrophobic internal phase/hydrophilic dispersed phase ratios, until they take on the shape of polyhedrons, which minimizes the volume occupied by the aqueous continuous phase.

We have also shown that a HIPE emulsion of the invention may undergo processing to create a dry emulsion, e.g., when the hydrophobic internal phase is made up of a polymerizable or nonlyophilizable oil, and consequently only the aqueous continuous phase is eliminated through drying or lyophilization.

We have also shown that a HIPE emulsion of the invention may be used to create dry foams, e.g., (i) either by lyophilization of said emulsions when the 2 phases are lyophilizable, or (ii) when the hydrophobic dispersed phase includes polymerizable monomers, through polymerization of said monomers followed by elimination of the aqueous continuous phase.

Generally speaking, the applicant has shown that the production of an elevated internal phase emulsion, specifically a HIPE emulsion stabilized by cellulose nanocrystals, is influenced by the features of the Pickering emulsion that is provided for its preparation. As is described in greater detail herein below, certain features of the starting Pickering emulsion are important for producing a HIPE emulsion of the invention, including:
the size of the cellulose nanocrystals,
the charge density of the cellulose nanocrystals,
the rate of recovery by the cellulose nanocrystals,
the hydrophobic dispersed phase/hydrophilic continuous phase volume ratio, and
if necessary, the ionic strength of the composition.

### Provision of a Pickering Oil-in-Water Emulsion Stabilized by Cellulose Nanocrystals.

### Pickering Emulsion Composition

The Pickering emulsion used for producing a MIPE or HIPE emulsion of the invention consists of a composition in the form of an emulsion comprising a hydrophobic phase dispersed in an aqueous phase, and containing emulsifying (or “emulsioning”) particles consisting of cellulose nanocrystals.

As was already specified, the Pickering emulsion is of the “oil-in-water” type.

The Pickering emulsion is stabilized by cellulose nanocrystals.

The cellulose nanocrystals are known in the prior art, often under the name of cellulose “whiskers” or cellulose “nanowhiskers.”

These cellulose nanocrystals may originate from various sources: plant (e.g., wood pulp, cotton, or algae), animal (e.g., tunicates), bacterial, or regenerated cellulose. They are described, e.g., in Samir et al. (2005, Biomacromolecules, Vol. 6: 612-626) or in Elazzouzi-Hafraoui et al. (Biomacromolecules, 2008; 9(1): 57-65).

More specifically, cellulose nanocrystals are highly-crystalline solid particles.

These cellulose nanocrystals are devoid of, or nearly devoid of, amorphous parts. They preferably offer a crystallinity rate of at least 60%, and preferably ranging from 60% to 95% (see, e.g., Elazzouzi-Hafraoui et al., 2008, already cited).

Advantageously, the cellulose nanocrystals are elongated in shape; that is, advantageously having a length/width ratio higher than 1.

Advantageously, the cellulose nanocrystals are acicular in shape; that is, with a linear, pointed shape like a needle. This morphology may be observed, e.g., by electron microscopy, specifically by transmission electron microscopy (or “TEM”).

Advantageously, the cellulose nanocrystals have the following size characteristics: (i) a length ranging from 25 nm to 10 μm, and (ii) a width ranging from 5 to 30 nm. Preferably, the cellulose nanocrystals have a length smaller than 1 μm.

By “length,” we mean the largest dimension of the nanocrystals separating two points located at the ends of their respective longitudinal axis.

By “width,” we mean the dimension measured along the nanocrystals, perpendicular to their respective longitudinal axis and corresponding to their maximum cross section.

In preferred embodiments, the cellulose nanocrystals form a relatively homogeneous population of nanocrystals whose test length values follow a Gaussian distribution centered on the length value assigned to said population of nanocrystals. In these preferred embodiments, one may use, e.g., cellulose nanocrystals with a “single determined size,” as is illustrated in the examples.

In actual practice, the morphology and dimensions of the nanocrystals may be determined by using various imaging techniques such as transmission electron microscopy (TEM) or atomic force microscopy (AFM), small-angle x-ray scattering (SAXS) or small-angle neutron scattering (SANS), or dynamic light scattering (DLS).

According to a preferred embodiment, the cellulose nanocrystals have the following dimensions: (i) a length ranging from 100 nm to 1 μm, and (ii) a width ranging from 5 to 20 nm.

Also advantageously, the cellulose nanocrystals have a length/width ratio higher than 1 and lower than 100, preferably ranging from 10 to 55.

A length/width ratio higher than 1 and lower than 100 covers the length/width ratios of at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99.

A length/width ratio ranging from 10 to 55 covers the length/width ratios selected from 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51 52, 53, and 54.

For example, the nanocrystals produced from cotton cellulose advantageously have a length ranging from 100 nm to 200 nm, for a width ranging from 12 to 15 nm.

In certain cellulose nanocrystal embodiments, the length/width ratio advantageously ranges from 7 to 17.

According to another example, the nanocrystals may be produced from bacterial cellulose (known as “bacterial cellulose nanocrystals,” “BCN,” or “BMCC”). Such nanocrystals advantageously have a length ranging from 600 nm to 1 μm, for a width ranging from 12 to 17 nm.

In certain cellulose nanocrystal embodiments, the length/width ratio advantageously ranges from 35 to 83.

In yet another embodiment, the cellulose nanocrystals produced from Cladophora cellulose advantageously have a length ranging from 3 to 5 μm (advantageously around 4 μm) for a width of 20+/−5 nm. The length/width ratio advantageously ranges from 150 to 250, preferably around 160.

To optimize the stability of Pickering emulsions, the cellulose nanocrystals are advantageously selected based on their surface characteristics, taking into particular account (i) electrostatic appearance and/or (ii) hydrophilicity.

Concerning surface electrostatic appearance, the cellulose nanocrystals stabilizing the emulsion advantageously have a maximum surface charge density of 0.67 e·nm⁻², specifically 0.5 e·nm⁻², and even more specifically a maximum surface charge density of 0.3 e·nm⁻². Note that “e” corresponds to an elementary charge.

The surface charge density may, if required, be selected based on the aqueous phase ionic strength.

Advantageously, this surface charge density is determined via conductometric assay, e.g., as described in Example 1.

More specifically, and according to one embodiment, the cellulose nanocrystals have a charged surface, with a surface charge density ranging from 0.01 e·nm⁻² and 0.31 e·nm⁻².

As is described in the examples, the desired surface charge density may be produced by controlling the degree of nanocrystal sulfation. The degree of nanocrystal sulfation may be controlled by having the cellulose nanocrystals undergo a sulfation treatment and, if necessary, a subsequent desulfation treatment.

The applicant has shown that a stable Pickering emulsion is produced when practically uncharged cellulose nanocrystals are used.

The applicant has also shown that beyond 0.31 e·nm⁻², the stability of the Pickering emulsion is very significantly altered. The applicant has shown that cellulose nanocrystals with an overly high charge density value have an overly hydrophilic surface and are found in large quantities in suspension in the aqueous phase instead of being located at the oil/water interface in order to stabilize the emulsion.

In this case, the cellulose nanocrystals advantageously have negative surface charges, which are advantageously carried by surface anionic groups.

The anionic groups of the cellulose nanocrystals are selected, e.g., from sulfonate groups, carboxylate groups, phosphate groups, phosphonate groups, and sulfate groups.

The transposition of a degree of substitution (DS) value to the corresponding surface charge density value (e·nm⁻²) is direct, once the charge number of the relevant chemical group is known. By way of illustration, for sulfate groups, which carry a single charge, the DS value (number of sulfate groups per surface unit) is identical to the surface charge density value (number of charges per identical surface unit).

In other terms, the cellulose nanocrystals have a degree of substitution (DS) ranging from 10⁻³ to 10⁻² e/nm², or a degree of surface substitution (DSS) ranging from DS/0.19 to DS/0.4, depending upon the morphology of the nanocrystals used.

According to another embodiment, the cellulose nanocrystals have a neutral surface. In this case, the surface charge density is advantageously lower than or equal to 0.01 e·nm⁻².

Generally speaking, the cellulose nanocrystals used according to the invention are cellulose nanocrystals that have not undergone hydrophobization treatment. This covers cellulose nanocrystals whose hydroxyl groups have not been functionalized by atoms or hydrophobic groups. Typically, this covers nanocrystals that have not undergone hydrophobization treatment by esterification of hydroxyl groups by organic acids.

In advantageous embodiments, the cellulose nanocrystals that are used to produce the Pickering emulsion do not undergo any chemical treatment after they are produced, other than a desulfation or sulfation treatment. Specifically, we preferably use cellulose nanocrystals that have not been functionalized or grafted with groups enabling their subsequent cross-linking, e.g., by methacrylate or dimethacrylate groups. Additionally, we preferably use cellulose nanocrystals that have not been functionalized or grafted by polymer molecules, such as a polyethylene glycol, a poly(hydroxyester), or a polystyrene.

The applicant has also shown that the stability of the Pickering emulsion may be improved by using an aqueous phase that has a determined minimum ionic strength.

As is shown in the examples with cellulose nanocrystals, optimal stability of the emulsion is produced starting from a minimum ionic strength value threshold of the aqueous phase.

As is shown in the examples, maximum stability of the Pickering emulsion is produced for an ionic strength value corresponding to a final NaCl concentration of 0.02 M in said emulsion.

Without wishing to be constrained by any particular theory, the applicant believes that the ionic strength threshold value of the aqueous phase at which optimal stability of the emulsion is produced is the one at which the charges (counterions) that are present in the aqueous phase neutralize the charges (ions) that are present on the nanocrystals.

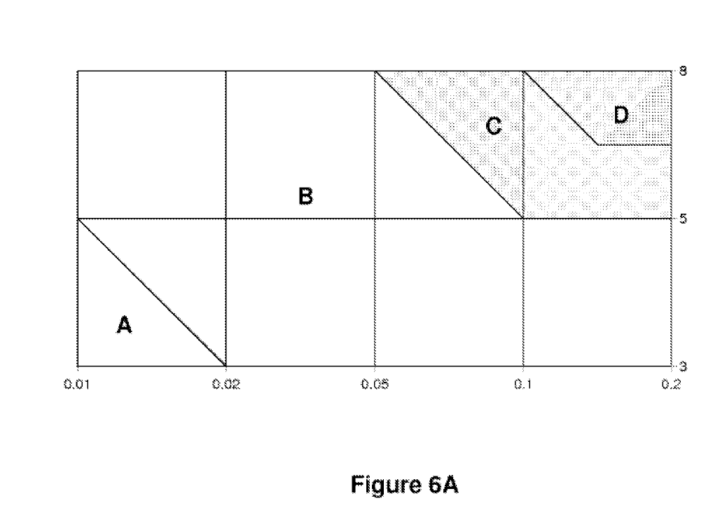

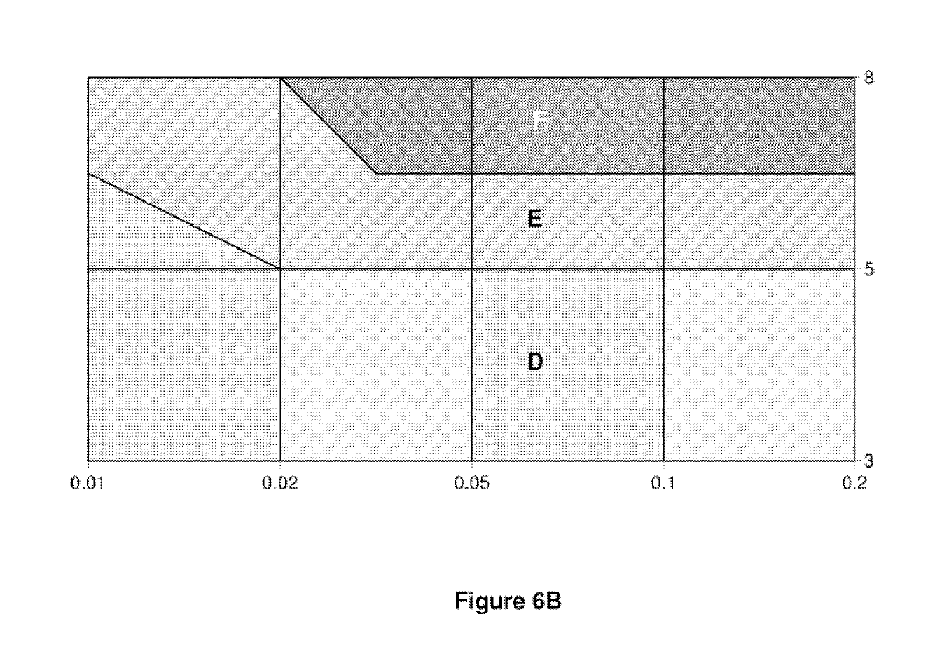

As is shown in the examples, the presence of excess counterions does not significantly influence the emulsion's stability properties. For a massive excess of counterions, which was not achieved in the test conditions of the examples, we may predict a variation in the conditions due to precipitation of the nanocrystals without necessarily changing the emulsion's stability (the aggregation phenomenon has proven to be quite favorable for stabilization of the emulsion—see FIG. 6).

As a guide, according to a specific embodiment, for a composition including an ionic strength lower than the ionic strength equivalent to 10 mM NaCl, the cellulose nanocrystals advantageously have a maximum surface charge density of 0.03 e·nm⁻².

For a composition including an ionic strength that is higher than the ionic strength equivalent to 10 mM NaCl, the surface charge density carried by the cellulose nanocrystals appears to no longer be a relevant parameter for effective stabilization of the emulsion.

An ionic strength higher than the ionic strength equivalent to 10 mM NaCl includes an ionic strength higher than 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 210, 220, 230, 240, 250, 260, 270, 275, 280, 290, 300, 310, 315, 320, 325, 330, 335, 340, 345, 350, 360, 370, 375, 380, 390, 400, 410, 420, 430, 440, 450, 460, 470, 480, 490, or higher than 500 mM NaCl. Preferably, the ionic strength is lower than an ionic strength equivalent to 3 M NaCl.

The results of the examples show that, in certain embodiments of an emulsion of the invention, the stability of said emulsions is already maximal for an ionic strength of the composition of 20 mM NaCl, and the emulsion's stability level is kept nearly unchanged for all of the tested ionic strength values; that is, at least up to an ionic strength value equivalent to the ionic strength of 0.5 M NaCl.

The cellulose nanocrystals are generally incorporated into the aqueous phase of the composition.

According to a preferred embodiment, the Pickering emulsion composition is stabilized solely by the cellulose nanocrystals, without adding any other emulsifying or stabilizing compound.

According to a preferred embodiment, the Pickering emulsion composition contains no solid particles, regardless of whether said solid particles are nonfunctionalized or functionalized, other than the cellulose nanocrystals.

The composition advantageously contains from 0.035% to 2% by weight, preferably from 0.05% to 1% by weight, of cellulose nanocrystals in relation to the total weight of said composition.

This weight ratio of cellulose nanocrystals may be evaluated, e.g., by dry extract of the aqueous phase or by saccharimetry following hydrolysis.

We have shown, according to the invention, that a sufficiently high quantity of cellulose nanocrystals for producing a recovery rate of at least 40% (e.g., for Cladophora cellulose nanocrystals), preferably 60% (e.g., for bacterial cellulose nanocrystals—BCN), based on the type of nanocrystals used, is required for the preparation of a Pickering emulsion composition that is suitable for producing a final MIPE or HIPE emulsion composition according to the invention.

The applicant has observed that a stable Pickering emulsion cannot be formed when the quantity of cellulose nanocrystals is lower than what enables a recovery rate of approximately 40%, preferably approximately 60%. Specifically, when one uses a weight of nanoparticles that is too low in relation to the volume of oil, coalescence of the droplets in the hydrophobic phase occurs, tending to result in a minimal recovery of 40%, preferably 60%. The poor stability of the resulting Pickering emulsion does not enable the subsequent production of the MIPE or HIPE emulsion according to the invention, at least under satisfactory conditions. Specifically, the applicant has observed that it is impossible to produce a stable Pickering emulsion with a cellulose nanocrystal recovery rate lower than 40%, preferably lower than 60%; it is thus impossible to produce a MIPE or HIPE emulsion.

In the present description, the “recovery rate” by cellulose nanocrystals represents the proportion of the surface of the hydrophobic phase droplets dispersed in the aqueous phase, at the oil/water interface that is recovered by the cellulose nanocrystals.

The recovery rate “C,” which is the ratio between (i) the cellulose nanocrystal surface present in the emulsion composition that is likely to stabilize at the hydrophobic internal phase/hydrophilic continuous phase interface, and (ii) the total surface of the hydrophobic-phase droplets in said emulsion composition, is calculated according to the following formula (I):

C=Sₚ/S_{d} (I), wherein:
Sₚ represents the cellulose nanocrystal surface present in the emulsion composition that is likely to stabilize at the interface, and
S_{d} represents the total surface of the hydrophobic phase droplets in the emulsion composition.

The surface of the nanocrystals is assimilated into a single-plane surface, following the hypothesis that the nanocrystals are aligned on said surface in a flat strip.

Consequently, the surface value of the nanocrystals may be calculated using the following formula (II):

$${S}_{p} = {N}_{p} Ll = \frac{{m}_{p}}{h {ρ}_{p}} , \\ with \text{:} {N}_{p} = \frac{{m}_{p}}{Vp \times {ρ}_{p}} = \frac{{m}_{p}}{L \times l \times h \times {ρ}_{p}} \qquad ( II )$$

wherein:
Sₚ represents the surface of cellulose nanocrystals present in the emulsion composition that are likely to stabilize at the interface,
Nₚ signifies the number of cellulose nanocrystals present in the aqueous phase,
L signifies the length of the cellulose nanocrystals,
I signifies the width of the cellulose nanocrystals,
h signifies the height of the cellulose nanocrystals,
mₚ signifies the mass of the cellulose nanocrystals, and
ρ signifies the density of the cellulose nanocrystals

The surface of the droplets is the surface at the oil/water interface, which was calculated for each average droplet diameter according to D(3,2).

Consequently, the surface value of the droplets may be calculated according to the following formula (III):

$$\begin{matrix}{S}_{d} = 4 π {R}^{2} \times Ng = 4 π {R}^{2} \times \frac{3 {V}_{oil}}{4 π {R}^{3}} = \frac{3 {V}_{oil}}{R} , & ( III ) \\ with \text{:} {N}_{g} = \frac{Voil}{4 / 3 π {R}^{3}} & ( IV )\end{matrix}$$

wherein:
N_{g} signifies the number of drops present in the emulsion
S_{d} signifies the surface value of the hydrophobic phase droplets,
R signifies the average radius of the droplets, and
Vₒᵢₗ signifies the total volume of the hydrophobic internal phase.

The final value of recovery rate “C” is calculated using formula (I), mentioned above:

C=Sₚ/S_{d} (I), wherein:
Sₚ represents the cellulose nanocrystal surface present in the emulsion composition that is likely to stabilize at the interface, and
S_{d} represents the total surface of the hydrophobic phase droplets in the emulsion composition.

In the Pickering emulsion composition, the hydrophobic dispersed phase advantageously represents less than 50% by volume in relation to the total volume of the composition.

The hydrophobic phase is selected from vegetable oils, animal oils, mineral oils, synthetic oils, hydrophobic organic solvents, and hydrophobic liquid polymers.

The Pickering emulsion composition may also contain any other compound appropriate for its final use or destination.

The Pickering emulsion composition may thus be adapted to the application sought for the final HIPE composition; specifically, the application may be selected from compositions usable in the food, cosmetic, pharmaceutical, or phytosanitary fields.

As is known, and depending upon the desired application for the final MIPE or HIPE emulsion composition of the invention, the Pickering emulsion composition may contain, for example, in entirely nonlimiting fashion, active ingredients and additives such as preservatives, gelling agents, solvents, dyes, etc.

### Method for Producing the Pickering Emulsion Composition

The method for manufacturing the Pickering emulsion composition advantageously includes the following steps:

(a) providing cellulose nanocrystals as defined above, then
(b) incorporating said cellulose nanocrystals into the aqueous phase of said composition, in a mass quantity suitable for generating a recovery rate of at least 60% in said Pickering emulsion and for stabilizing said emulsion.

The general steps for manufacturing the emulsion may be conducted according to traditional procedures, specifically those used for manufacturing a Pickering emulsion.

Specifically, the step for incorporating cellulose nanocrystals into the aqueous phase corresponds to implementation steps for incorporating colloidal particles during the manufacture of Pickering emulsions.

Generally speaking, a Pickering emulsion, which is produced or provided in Step

a) of the method for producing a HIPE emulsion according to the invention, is prepared according to a method including the following steps:
1) providing the appropriate volumes, respectively, of the hydrophilic phase and of the hydrophobic phase,
2) dispersing the hydrophobic phase in the hydrophilic phase.

Either of the hydrophilic or hydrophobic phases contains the appropriate quantity of cellulose nanocrystals.

Preferably, since the cellulose nanocrystals used are hydrophilic, or at least are not hydrophobic, said cellulose nanocrystals are present in the hydrophilic phase.

Step 2), for dispersing the hydrophobic phase in the hydrophilic phase, may be performed using any technique for creating an emulsion known to a person skilled in the art.

One may thus, e.g., use a technique for producing emulsions using ultrasound, as is traditionally done. One may also use an emulsion production technique that involves stirring using a rotor-stator-type disperser/homogenizer device, e.g., a rotor-stator device known by the name of Ultraturrax™, well known to a person skilled in the art.

By way of illustration, one may produce a Pickering emulsion stabilized by cellulose nanocrystals, the starting material for the method for producing a MIPE or HIPE emulsion according to the invention, by having a (i) hydrophilic phase/(ii) hydrophobic phase mixture, with said mixture containing the appropriate quantity of cellulose nanocrystals, undergo an ultrasound homogenization step for a duration of several seconds to several minutes depending upon the power level of the device and the emulsion volume.

Also by way of illustration, one may produce a Pickering emulsion stabilized by cellulose nanocrystals, the starting material for the method for producing a MIPE or HIPE emulsion according to the invention, by having a (i) hydrophilic phase/(ii) hydrophobic phase mixture, with said mixture containing the appropriate quantity of cellulose nanocrystals, undergo an ultrasound homogenization step using a Heidolph-type rotor-stator device (Rothυ) at a speed of at least 40000 rev/min (rpm) for a duration of 1 to 3 minutes.

The cellulose nanocrystals provided in Step a) of the method for producing a MIPE or HIPE emulsion of the invention are advantageously produced by a manufacturing method using a cellulose.

The cellulose is advantageously selected from at least one of the celluloses having the following origin: plant, animal, bacterial, algal, or regenerated from a commercially-sourced transformed cellulose.

The main cellulose source is plant fiber. Cellulose is present therein as a component of the cell wall, in the form of microfibril bundles.

Part of these microfibrils is composed of so-called “amorphous” cellulose, while a second part is made up of so-called “crystalline” cellulose.

The cellulose nanocrystals advantageously originate from crystalline cellulose isolated from plant fibers, by eliminating the amorphous cellulose part.

Among plant sources, we may list, e.g., cotton, birch, hemp, ramie, linen, and spruce.

Among algal cellulose sources, we may list, e.g., Valonia or Chladophora (or Cladophora).

Among bacterial cellulose sources, we may list Gluconoacetobacter xylinus, which produces Nata de coco through direct incubation in coconut milk.

Among animal cellulose sources, we may list, e.g., tunicates.

Cellulose may also be regenerated from a commercially-sourced transformed cellulose, specifically in the form of paper.

We may list, e.g., Whatman™ filter paper for producing cotton cellulose.

Starting with the selected cellulosic raw material, the cellulose nanocrystals are prepared by a method that is advantageously selected from one of the following methods: mechanical fractionation, graded chemical hydrolysis, and dissolution/recrystallization.

By “mechanical fractionation,” we mean a traditional high-pressure homogenization operation.

By “graded chemical hydrolysis,” we mean treatment of the cellulose with an acidic chemical compound, under conditions that ensure elimination of its amorphous part.

The acidic chemical compound is advantageously selected from sulfuric acid or hydrochloric acid.

As described in the examples hereinafter, the surface charge may be modulated depending upon the type of acid, temperature, and hydrolysis time.

Thus, hydrolysis using hydrochloric acid will result in a near-neutral surface condition, whereas hydrolysis using sulfuric acid will result in sulfate charges (SO₃ group) on the surface of the cellulose nanocrystals.

These types of “graded chemical hydrolysis” treatments are, e.g., described in the above cited document Elazzouzi-Hafaoui et al. (2008) or in the document Eichhorn S. J. et al. (“Review: Current International Research into Cellulose Nanofibers and Nanocomposites.” J Mater Sci 2010, 45, 1-33).

By “dissolution/recrystallization,” we mean a treatment with a solvent, e.g., phosphoric acid, urea/NaOH, ionic liquids, etc., followed by recrystallization. This type of method is described, e.g., in the document Helbert et al. (Cellulose, 1998, 5, 113-122).

Prior to their integration into the composition, the produced cellulose nanocrystals advantageously undergo a post-modification method, following which their surface charge density and/or their hydrophilicity are modified, provided that the post-modification does not generate hydrophobic cellulose nanocrystals.

This post-modification aims to optimize the surface characteristics of the cellulose nanocrystals, specifically depending upon the emulsion into which they are introduced, in order to optimize its stabilization.

In order to modify the surface charge density, the post-modification method advantageously consists of a method for introduction or hydrolysis of surface groups carrying said surface charges.

In this case, the post-modification operation consists of a step for introduction or hydrolysis of surface groups selected from the sulfonate, carboxylate, phosphate, phosphonate, and sulfate groups.

As a guide, for introducing the respective surface groups, one may implement a method such as the one described in the document Habibi Y. et al. “TEMPO-mediated Surface Oxidation of Cellulose Whiskers,” Cellulose, 2006, 13 (6), 679-687.

Also as a guide, and conversely, for hydrolysis of such surface groups, one may implement an acid treatment as described hereinafter in the Examples section, or a sonification-type mechanical treatment.

In this context and according to an initial embodiment, the manufacturing method consists of a method for graded acid hydrolysis of the cellulose by sulfuric acid, in order to produce cellulose nanocrystals with surface sulfate groups. According to this embodiment, the method for post-modification of cellulose nanocrystals carrying surface sulfate groups preferably consists of a method for controlled hydrolysis of said sulfate groups, namely, e.g., via an acid treatment (selected, e.g., from hydrochloric acid or trifluoroacetic acid) over a time period that is suitable for the desired level of hydrolysis.

According to a second embodiment, the manufacturing method consists of a method for graded acid hydrolysis of the cellulose by hydrochloric acid. According to this embodiment, the optional post-modification method consists of a method for post-sulfation of said cellulose nanocrystals. This type of post-sulfation is advantageously implemented via an acid treatment of the nanocrystals using sulfuric acid.

The above described Pickering emulsion composition is used to produce the medium internal phase emulsion (MIPE) or high internal phase emulsion (HIPE) of the invention, as is described hereinafter.

### Producing the Medium Internal Phase Emulsion (MIPE) or High Internal Phase Emulsion (HIPE)

If the stability condition of the Pickering emulsion is met (Step a)), the method can be continued by the step or steps for forming the MIPE or HIPE emulsion (Step b)).

According to the invention, production of the MIPE emulsion can be carried out:
by adding a volume of hydrophobic phase to the emulsion composition produced in Step a), and/or
by concentrating the emulsion composition produced in Step a) by removing at least part of said hydrophilic phase.

The Examples hereinafter show that these MIPE emulsions have an internal phase percentage ranging from 55% to 74-75%, without rupture of the emulsion (coalescence).

Also according to the invention, the production of the HIPE emulsion requires reaching a concentration of hydrophobic drops that exceeds the “close packing” threshold, or the theoretical maximum space occupied by spheres of identical size, corresponding to an internal phase percentage higher than 74-75%.

To do this, in nonlimiting fashion, there are two possible approaches:
variable internal phase droplet size, and
swelling of the internal phase droplets, followed by their deformation.

The Examples hereinafter show that the Pickering emulsion of the invention enables production of the desired HIPE emulsion, whose internal phase percentage is higher than 74-75%.

### Adding a Volume of Hydrophobic Phase

According to a first embodiment, the method may be continued by adding the hydrophobic phase in order to form the MIPE or HIPE emulsion (Step b.1)).

To produce a MIPE or HIPE emulsion of the invention from a Pickering emulsion prepared as described above, we advantageously add a desired quantity of hydrophobic phase to said emulsion before stirring the Pickering emulsion/added hydrophobic phase mixture.

Unexpectedly, the applicant has shown that simply stirring the Pickering emulsion/added hydrophobic phase mixture with a homogenizer device (e.g., Ultraturrax™) enables direct production of an MIPE or HIPE emulsion.

As is shown in the examples, in a MIPE or HIPE emulsion of the invention, the value of the hydrophobic dispersed phase volume/emulsion volume ratio (and therefore also the value of the hydrophobic dispersed phase volume/hydrophilic continuous phase volume ratio) depends directly on the volume of the hydrophobic phase added to the starting Pickering emulsion.

As is additionally shown in the examples, there appears to be no specific limit on the value of the hydrophobic dispersed phase/aqueous continuous phase volume ratio in the HIPE emulsion thereby produced.

In a MIPE or HIPE emulsion of the invention, the value of the hydrophobic dispersed phase/emulsion volume ratio is determinable in advance, depending upon the volume of hydrophobic phase added to the starting Pickering emulsion.

By way of illustration, a HIPE emulsion of the invention having an internal phase percentage of 90% was produced by adding 16 mL of hydrophobic phase to 2 mL of aqueous phase corresponding to a 5 g/L cellulose nanocrystal suspension. Therefore, this HIPE emulsion can stabilize the hydrophobic phase with 1.8 mg of cellulose particles.

In the same way, a theoretical calculation enables us to state that a HIPE emulsion of the invention having an internal phase percentage of 98% can be produced by adding 100 mL of hydrophobic phase to 2 mL of Pickering emulsion stabilized by the cellulose nanocrystals.

The step involving stirring the Pickering emulsion/added hydrophobic phase mixture can be performed easily by using a traditional homogenizer/disperser device, e.g., an Ultraturrax™-type stirring device.

By way of illustration, when an Ultraturrax™-type stirring device is used, the HIPE emulsion can be produced by stirring for a time period of at least 30 seconds at a rotation speed of at least 1000 revolutions per minute, preferably at least 5000 revolutions per minute.

A person skilled in the art will adapt the conditions of the step for stirring the mixture based on the indications of the present description and on his/her general knowledge in the field of emulsion composition manufacture;

For the mixture-stirring step, a time period of at least 30 seconds covers the time periods of at least 35, 40, 45, 50, 55, 60, 65, 70, 75, 80, 90, 95, 100, 105, 110, 115, 120, 125, 130, 135, 140, 145, 150, 155, 160, 165, 170, 175, 180, 185, 190, 195, and 200 seconds.

If necessary, the stirring step may have a time period longer than 200 seconds, although this is not useful for producing the final HIPE emulsion.

For the stirring step, a stirring force of at least 1000 revolutions per minute covers the stirring forces of at least 1050, 1100, 1150, 1200, 1250, 1300, 1350, 1400, 1450, 1500, 1550, 1600, 1650, 1700, 1750, 1800, 1850, 1900, 2000, 2100, 2200, 2300, 2400, 2500, 2600, 2700, 2800, 2900, 3000, 3100, 3200, 3300, 3400, 3500, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, or at least 10000 revolutions per minute.

If necessary, a stirring force higher than 15000 revolutions per minute may be applied, although this is not useful for producing the final HIPE emulsion.

Preferably, under the general stirring conditions defined above, the stirring force is lower than 200000 revolutions per minute, in order to avoid altering the structure of the emulsion. The stirring force may be easily adapted by a person skilled in the art in light of the contents of the present description, and, if applicable, his/her general knowledge. Specifically, the stirring force may be adapted by a person skilled in the art depending upon the viscosity of the starting Pickering emulsion, and depending upon the increase in viscosity during preparation of the HIPE emulsion, which depends in particular on the viscosity of the hydrophobic phase that is added.

In certain embodiments, the step involving stirring with an Ultraturrax™-type device can be performed in two phases; respectively, a first phase during which a first stirring force is applied and a second phase during which a second stirring force is applied.

By way of illustration, the stirring step can be performed with (i) a first stirring phase at 11000 revolutions per minute and (ii) a second stirring phase at 15000 revolutions per minute, e.g., with a time period that is approximately identical for the first and second stirring phase.

Advantageously, the step for stirring the Pickering emulsion/added hydrophobic phase mixture is performed at room temperature; that is, in general, at a temperature ranging from 15° C. to 25° C., and more often ranging from 18° C. to 23° C.

### Concentration of the Emulsion Composition

According to a second embodiment, the method can be continued by a concentration step, in order to form the MIPE or HIPE emulsion (Step b.2)).

This concentration step leads to removing the hydrophilic continuous phase using an adapted technique, selected, e.g., from:
gravity-induced creaming/sedimentation,
centrifugation (e.g., 2000 g for 10 minutes),
filtration (advantageously, a traditional porous membrane system or continuous ultrafiltration system),
osmotic methods,
cryo-concentration or drying methods (under conditions where only the continuous phase is evaporated).

As is shown in the examples, in a MIPE or HIPE emulsion of the invention, the value of the hydrophobic dispersed phase volume/emulsion volume ratio (and therefore also the value of the hydrophobic dispersed phase volume/hydrophilic continuous phase volume ratio) depends specifically upon:
the concentration of each of the constituents (hydrophilic phase, hydrophobic phase, nanocrystals),
the method for producing the emulsion (ultrasound, rotor-stator, etc.), and
the conditions used (speed, time, temperature, energy, volume, etc.).

The parameters of these techniques will be adapted to suit the sample.

Such methods are described, e.g., in the following documents: “Emulsions: Theory and Practice,” Paul Becher, Third Edition, Oxford University Press 2001 (ISBN 0-8412-3496-5) or “High Internal Phase Emulsions (HIPEs)—Structure, Properties and Use in Polymer Preparation,” Cameron N R; Sherrington D C, BIOPOLYMERS LIQUID CRYSTALLINE POLYMERS PHASE EMULSION, ADVANCES IN POLYMER SCIENCE, Volume: 126, Pages: 163-214, 1996.

### The Hydrophobic Phase

In certain embodiments, the hydrophobic phase that is added to the Pickering emulsion is identical to the hydrophobic phase constituting the hydrophobic dispersed phase contained in said Pickering emulsion.

In other embodiments, the hydrophobic phase that is added to the Pickering emulsion is distinct from the hydrophobic phase contained in said Pickering emulsion.

Preferably, when the hydrophobic phase added to the Pickering emulsion is distinct from the hydrophobic phase contained in said Pickering emulsion, we use the added hydrophobic phase that is miscible in the hydrophobic phase initially contained in the Pickering emulsion.

The hydrophobic phase is selected from vegetable oils, animal oils, mineral oils, synthetic oils, hydrophobic organic solvents, and hydrophobic liquid polymers.

The hydrophobic phase may be selected from a substituted or nonsubstituted alkane or cycloalkane. The examples illustrate embodiments of a HIPE emulsion of the invention with alkanes and cycloalkanes, respectively.

The examples show that excellent results are obtained by using, as the hydrophobic phase, an alkane having a number of carbon atoms higher than 5.

For the hydrophobic phase, an alkane having more than 5 carbon atoms covers alkanes having more than 6, 7, 8, 9, 10, 11, 12, 13, 14, 15, 16, or more than 17 carbon atoms; that is, specifically, according to the traditional nomenclature, C₆-C₁₈ alkanes that have the formula CₙH₂ₙ₊₂. Said alkanes may be linear or branched.

Said alkanes encompass hexane, heptane, octane, nonane, decane, undecane, dodecane, tridecane, tetradecane, pentadecane, hexadecane, heptadecane, and octadecane linear or branched alkanes.

The substituted alkanes encompass the above linear or branched alkanes of which at least one hydrogen atom is substituted by a halogen selected from chlorine, bromine, iodine, or fluorine. The substitution of at least one hydrogen atom covers the substitution of 2, 3, 4, or 5 hydrogen atoms.

The examples also show that excellent results are obtained by using, as the hydrophobic phase, a cycloalkane having at least 6 carbon atoms; said cycloalkane is substituted or nonsubstituted.

In certain embodiments, said cycloalkane is a nonsubstituted or substituted cyclohexane. The cyclohexane may be substituted by 1, 2, 3, or 4 halogen atoms selected from chlorine, bromine, iodine, or fluorine.

The hydrophobic phase may also include a mixture of such alkanes, e.g., in the form of a paraffin oil.

In certain embodiments, the hydrophobic phase includes one or several known polymerizable hydrophobic monomers.

In other embodiments, the hydrophobic phase essentially consists of a composition of a hydrophobic monomer or a mixture of hydrophobic monomers. By way of illustration, the hydrophobic phase may essentially consist of a composition of styrene monomers.

The embodiments wherein the hydrophobic phase includes, or consists of, a hydrophobic monomer or a combination of hydrophobic monomers, are particularly useful for manufacturing beads of polymer material (through polymerization of this/these monomer(s)).

### The Hydrophilic Phase

By “hydrophilic phase” or “aqueous phase,” we mean a liquid that is immiscible with the hydrophobic phase. A hydrophilic phase that is miscible with water is preferably used. The hydrophilic phase may be water, as is illustrated in the examples.

The hydrophilic phase may be a hydrophilic solvent, preferably a solvent carrying hydroxyl groups, such as glycols. For the hydrophilic phase, the glycols encompass glycerol and polyethylene glycols.

The hydrophilic phase may also contain hydrosoluble texturizers, specifically thickeners or viscosifiers, such as polysaccharides (e.g., dextran or xanthan; the latter is widely used in foodstuff applications).

The hydrophilic phase may be constituted, partially or totally, of an organic liquid selected from an alcohol such as ethanol, or from acetone.

The hydrophilic phase may include a single liquid or a mixture of several liquids.

A person skilled in the art may easily adapt the constitution of the hydrophilic phase, particularly depending upon whether a final MIPE or HIPE emulsion is desired. By way of illustration, when an alcohol such as ethanol is used to form the hydrophilic phase, it may be advantageous for the hydrophilic phase to not be constituted exclusively of ethanol, in order to avoid inducing the precipitation of at least part of the cellulose nanocrystals in the hydrophilic phase. In order to prevent this disadvantage, a person skilled in the art will then preferably use a hydrophilic phase containing a water/ethanol mixture.

In certain embodiments, the hydrophilic phase may include various additional substances or a combination of additional substances that are useful for the industrial application sought for the MIPE or HIPE emulsion, such as active drug ingredients.

In certain embodiments, the hydrophilic phase includes one or several hydrophilic monomers that may subsequently be polymerized within the MIPE or HIPE emulsion.

In certain embodiments, the hydrophilic phase includes one or several known polymerizable hydrophilic monomers.

In other embodiments, the hydrophilic phase essentially consists of a composition of a hydrophilic monomer or a mixture of hydrophilic monomers. By way of illustration, the hydrophilic phase may essentially consist of a composition of acrylate-type hydrophilic monomers.

The embodiments wherein the hydrophilic phase includes, or consists of, a hydrophilic monomer or a combination of hydrophilic monomers, are particularly useful for the manufacture of porous polymer material.

### Composition of the MIPE or HIPE Emulsion of the Invention

The formed emulsion composition includes a hydrophobic internal phase dispersed in a hydrophilic continuous phase, of the medium internal phase (MIPE) or high internal phase (HIPE) type.

The definitions developed above in the context of the method, in particular those relating to the internal phase percentage, the composition of the phases, or their proportions, also apply herein below.

This emulsion composition includes cellulose nanocrystals located at the interface between the hydrophobic internal phase and the hydrophilic phase.

According to the invention, the emulsion composition has an internal phase percentage higher than 55%.

According to one embodiment, the formed emulsion is advantageously a medium internal phase emulsion (MIPE), having an internal phase percentage ranging from 55% to 75%, more advantageously from 60% to 75%, even more advantageously from 65% to 75%, and still more advantageously from 70% to 75%.

According to another embodiment, the formed emulsion may be a high internal phase emulsion (HIPE), having an internal phase percentage higher than 75%, preferably higher than 80%, even more preferably higher than 85%, and yet more preferably higher than 90%. This internal phase percentage still more advantageously ranges from 80% to 90%, preferably from 85% to 90%.

In certain embodiments, we form in Step b) a MIPE or HIPE emulsion having a hydrophobic internal phase/hydrophilic continuous phase volume ratio that is higher than 60/40, preferably higher than 80/20.

By “higher than 60/40,” or “at least 60/40,” we mean a hydrophobic internal phase whose value is advantageously higher than 60 in the volume ratio, namely 65/35, 70/30, 75/25, 80/20, 85/15, or 90/10.

By “higher than 80/20” or “at least 80/20,” we mean a hydrophobic internal phase whose value is advantageously higher than 80 in the volume ratio, namely 85/15 or 90/10.

### Industrial Applications of a MIPE or HIPE Emulsion Composition of the Invention

As has already been mentioned in the present description and as is illustrated in the examples, a MIPE or HIPE emulsion of the invention may be produced for the purpose of preparing a dry foam or a dry emulsion, e.g., by simple lyophilization of the MIPE or HIPE emulsion.

To prepare a dry foam, a hydrophobic phase that can be evaporated by lyophilization is preferably used. Thus, by having a MIPE or HIPE emulsion of the invention undergo a lyophilization step, the hydrophilic phase and the hydrophobic phase are evaporated at the same time, so as to produce a foam formed of a cellulosic network, with said cellulosic network resulting from the cellulose nanocrystals located, in the starting MIPE or HIPE emulsion, at the hydrophobic phase/hydrophilic phase interface.

Specifically, the examples illustrate the manufacture of a cellulose foam material through simple lyophilization of a HIPE emulsion of the invention.

The dry foam may be used as a solid support in various industrial applications, including as heat or sound insulation material, or as biomaterial support.

The resulting product, namely the cellulosic foam, has a large specific surface of cellulosic material, and can be used as an active ingredient support, e.g., as a support for pharmaceutical, human, or veterinary active ingredient(s).

By way of illustration, these types of pharmaceutical supports may be produced when the active ingredient(s) is/are added early on to the MIPE or HIPE emulsion, either during the hydrophobic phase or in the hydrophilic phase, depending upon the relevant hydrophilicity characteristics or active ingredient(s).

In certain embodiments, said cellulosic supports may simultaneously include (i) one or several hydrophobic active ingredient(s), (ii) one or several hydrophilic active ingredient(s), and, if applicable, (iii) one or several amphiphilic active ingredient(s).

In these embodiments, each active ingredient may be added (i) either in one of the hydrophilic or hydrophobic phases used for the preparation of a Pickering emulsion in Step a) of the method of the invention, (ii) or in the Pickering emulsion used to produce the final MIPE or HIPE emulsion, (iii) or in the hydrophobic phase that is added in Step b) of the method in order to produce the final MIPE or HIPE emulsion.

Another goal of the invention is therefore a method for preparing a dry cellulose foam including the following steps:

a) providing a MIPE or HIPE emulsion as defined in the present description, preferably a MIPE or HIPE emulsion produced according to the method specified in the present description,

b) eliminating the hydrophilic phase and the hydrophobic phase of said MIPE or HIPE emulsion by evaporation, preferably by lyophilization, in order to produce the dry cellulose foam.

A MIPE or HIPE emulsion of the invention may also be used to manufacture a dry emulsion, by evaporating the hydrophilic phase, e.g., by lyophilization, and maintaining the hydrophobic phase. In these embodiments, the hydrophobic phase may contain one or several substance(s) of interest, e.g., one or several active drug ingredients.

A MIPE or HIPE emulsion of the invention may also be used to manufacture porous polymer materials, primarily by adding polymerizable hydrophilic monomers into the aqueous phase, followed by in situ polymerization of said hydrophilic monomers.

In other aspects, a MIPE or HIPE emulsion of the invention may be used to manufacture beads made of polymer material, primarily by adding hydrophobic monomers into the hydrophobic dispersed phase, followed by polymerization of said monomers.

The polymer materials may be used as material for manufacturing medical devices including support material for physiologically-active ingredients, or as support material for medical prostheses.

The techniques for producing polymer materials, either blocks of porous polymer material or beads of polymer material, from various emulsion types are known in the art.

In certain embodiments, said monomers of interest are already present in the hydrophilic continuous phase or in the hydrophobic dispersed phase that is used to produce the Pickering emulsion composition provided at the beginning of the method of the invention.

In other embodiments, said monomers of interest are present in the hydrophobic phase that is added to the starting Pickering emulsion, during the step when the actual MIPE or HIPE emulsion is created.

Also in other embodiments, said monomers of interest are added at a later stage to the MIPE or HIPE emulsion already produced.

In still other embodiments, the monomers of interest may be added successively at various steps, in the method for producing the MIPE or HIPE emulsion of the invention, and/or after the MIPE or HIPE emulsion composition of the invention is produced.

In certain embodiments, the polymer or polymers is/are used in combination with one or several cross-linking agents.

In order to polymerize the polymer or polymers of interest, one or several appropriate initiator compound(s) is/are traditionally added.

By way of illustration, the use of emulsions, including oil-in-water HIPE emulsions, for manufacturing polymer materials is described, e.g., in PCT Patent Application No. WO 2009/013500 or in U.S. Pat. No. 6,218,440 and U.S. Pat. No. 4,472,086.

The present invention is illustrated, in nonlimiting fashion, by the following examples.

### EXAMPLES

### Example 1

### Preparation of a Pickering Oil-in-Water Emulsion Stabilized by Cellulose Nanocrystals

### A. Protocols

### Protocol 1: Preparation of Bacterial Cellulose Nanocrystals

The method for producing bacterial cellulose nanocrystals is described, e.g., in the document N. R. Gilkes et al., J of Biological Chemistry 1992, 267 (10), 6743-6749.

BMCC fragments are nanofibrillated in a Waring mixer, at high speed, in an aqueous suspension containing ice cubes so as to combine shear and impact stress.

The produced paste is drained through polyamide filters, then suspended in a 0.5 N sodium hydroxide solution while stirring in a closed flask for two hours at 70° C.

Following elimination of alkaline elements via multiple rinses with water brought to pH 8, a bleaching step is performed with chlorite, producing a hollocellulose-type compound, as described in Gilkes et al. (Gilkes, N. R.; Jervis, E.; Henrissat, B.; Tekant, B.; Miller, R. C.; Warren, R. A. J.; Kilburn, D. G.; The Adsorption of a Bacterial Cellulase and Its 2 Isolated Domains to Crystalline Cellulose. J. Biol. Chem. 1992, 267 (10), 6743-6749).

Typically, a NaClO₂ solution, 17 g/L, is mixed with an identical volume of pH 4.5 acetate buffer (27 g of NaOH+75 g of acetic acid per liter).

The bleached bacterial cellulose is then suspended and heated while stirring at 70° C., for two hours.

These alkaline treatment and bleaching steps are repeated at least once in order to produce a bleached paste.

This bacterial cellulose is then hydrolyzed by means of a hydrochloric acid solution (2.5 N, two hours).

The acidic compounds are eliminated by successive operations until neutral: centrifugation (10000 g for 5 minutes) and dispersion in an 18 Mohm purified solution.

The produced cellulose nanocrystals are stored at 4° C. in the form of a 1% suspension, with the addition of one drop of CHCl₃ per 250 mL of suspension.

### Protocol 2: Preparation of Post-Sulfated Bacterial Cellulose Nanocrystals

An aqueous suspension of 1.34% bacterial cellulose nanocrystals, produced according to Protocol 1, is mixed with a solution of 2.2 M H₂SO₄ (or a 3/2 v/v ratio) while stirring vigorously at room temperature.

The sulfated cellulose nanocrystals are recovered by washing the beads in distilled water, and by successive centrifugation from 10000 rpm up to 76000 rpm for 10 to 30 minutes, producing a colloidal suspension.

Finally, the collected product is dialyzed until neutral, and the residual electrolytes are eliminated on ion exchange resin (TMD-8 mixed bed resin).

### Protocol 3: Desulfation of Post-Sulfated Bacterial Cellulose Nanocrystals

The suspension of 2.2% post-sulfated bacterial cellulose nanocrystals according to Protocol 2, [text missing] then heated for three hours at 100° C. in 2.5 N HCl, then washed by centrifugation at 6000 rpm for 5 minutes, repeated six times.

Finally, the collected product is dialyzed until neutral, and the residual electrolytes are eliminated on ion exchange resin (TMD-8 mixed bed resin).

Protocol 4: Preparation of Sulfated Cellulose Nanocrystals Originating from Cotton

The method for producing cotton cellulose nanocrystals is described, e.g., in the document Elazzouzi-Hafraoui et al. (2008).

25 g of paper is mixed in 900 mL deionized water, until a homogeneous mixture is produced.

165 mL of 98% sulfuric acid are added. The obtained product is maintained at 72° C. while stirring for 40 minutes.

The suspension is then cooled, washed in ultrapure water by successive centrifugations at 8000 rpm for 15 minutes, and dialyzed until neutral for three days against distilled water.

The residual electrolytes are then extracted using a mixed bed resin (TMD-8, hydrogen, and hydroxyl form) for 4 days.

The final dispersion, composed of sulfated cotton, is stored at 4° C.

### Protocol 5: Desulfation of Sulfated Cotton Nanocrystals

Desulfation of the sulfated cotton nanocrystals of Protocol 4 is carried out by means of an acid treatment, using 5 mL of a 5 N HCl solution or a 10 N trifluoroacetic acid solution (TFA), added to 5 mL of a suspension of sulfated cotton nanocrystals at a concentration of 13 g/L.

This acid treatment is implemented by heating at 98-100° C. while stirring, for 1, 2, 5, or 10 hours.

Alternatively, 5 mL of a 10 M TFA solution is added to 5 mL of cotton nanocrystals, with an incubation lasting 10 hours at 80° C. while stirring.

The two obtained products were rinsed with water by centrifugation (six times, 6000 rpm, for 5-7 min.).

### Protocol 6: Measuring the Degree of Sulfation via Conductometric Titration

Conductometric titration determines the degree of sulfation of the cellulose nanocrystals.

This type of method is described, e.g., in the document Goussé et al., 2002, Polymer 43, 2645-2651.

50 mL of an aqueous cellulose nanocrystal suspension (0.1% weight/volume) are stirred and degassed for 10 minutes, prior to titration with a 0.01 M NaOH solution.

The quantity of grafted sulfate is calculated while taking into account the fact that a single OH hydroxyl group can be substituted by a glucose unit, leading to a degree of sulfate substitution (DS) given by the following equations:

DS=(V_{eq}×C_{NaOH}×M_{w})/m

M_{w}=162/(1−(80×V_{eq}×C_{NaOH}/m))

wherein

V_{eq} is the quantity of NaOH in mL for reaching the equivalence point,
C_{NaOH} is the concentration of NaOH expressed in mol/L,
M_{w} is the mean molecular weight of a glucose unit,
m is the mass of titrated cellulose,
80 corresponds to the difference between the molecular weight of a sulfated glucose unit and the molecular weight of a nonsulfated glucose unit.

The value obtained by these equations must be corrected by the glucoside surface fraction (GSF), in order to obtain the degree of surface substitution, designated as “DSS.”

Depending upon the structure of the cellulose chains, only the primary OH groups (at C6) can be esterified, and only 50% of these OH groups are accessible at the surface due to the alternating conformation. Thus, the maximum DSS is 0.5.

Since the samples' morphology is variable, and in order to have a general application for all of the various cellulosic particles, a general equation was defined in order to determine the glucose surface fraction (GSF), taking into account the ratio of cross section (k) regardless of the particles' length.

Hence, for a given width (W×l) and an aspect ratio (k), we have:

GSF(k)=((2*((k*0.596)+0.532))/W×l)−4*((k*0.532*0.596)/W×l²)

### Protocol 7: Transmission Electron Microscopy

20 μL of an aqueous cellulose nanocrystal suspension (0.1% weight/volume) are placed on a carbon grid for electronic microscopy, the excess solvent is absorbed, and the sample is marked by adding uranyl acetate (2% in water).

This electron microscopy grid is then dried in a drying oven at 40° C.

The grids are then observed with a JEOL-brand transmission electron microscope (80 kV).

### Protocol 8: Preparation of an O/W Emulsion Stabilized by Nanocrystals

An initial oil-in-water Pickering emulsion is prepared by using an aqueous phase containing a known concentration of cellulose nanocrystals.

The emulsions are prepared using a 30/70 oil/water ratio starting with an aqueous phase containing nanoparticles at a concentration of 0.5% by weight, in relation to the weight of the emulsion (without additional dilution).

In an Eppendorf tube, 0.3 mL of hexadecane are added to 0.7 mL of the aqueous suspension; for 30 seconds, the mixture undergoes a treatment that alternates 2 seconds of ultrasound treatment with 5 seconds of rest.

### Protocol 9: Stability Test, Optical Microscopy

The emulsions produced according to Protocol 8 are centrifuged for 30 seconds at 10000 g; given the difference in density between hexadecane and water, creaming is observed. The emulsion volume is evaluated before and after centrifugation.

Approximately 15 μL of the Pickering solution is incorporated into 1 mL of distilled water. The product is mixed by a vortex mixer, then a drop is placed on a lamella for observation under the microscope.

The diameter of the droplets is measured based on images obtained through image analysis using an “imageJ” program.

Moreover, these results are compared to the drop size distribution determined by a Malvern MasterSizer device, using a light-diffraction device with analysis by Fraunhofer equation. The risk of clumping is, in this case, limited by the addition of SDS (sodium dodecyl sulfate) just before the measurement is taken.

### Protocol 10: Scanning Electron Microscopy (SEM)

To prepare the emulsion sample for observation by scanning electron microscopy (SEM), 280-380 mg of a styrene/initiator mixture (st. ratio: V-65 120:1 weight/weight) are mixed with 1.0 to 1.5 mL of solution to 0.5% of a sample water solution, subjected to ultrasound for 1-2 min., and degassed with nitrogen for 10 minutes.

The emulsion was produced by ultrasound treatment for 30 seconds (2-second pulses, separated by 5 seconds).

Next, 500 μL of water are added to the system, and then treated by vortex mixer.

This system is degassed with nitrogen for 10 minutes, and polymerization occurs at 63° C. without stirring for 24 hrs.

The resulting preparation then undergoes a metallization step using traditional scanning electron microscopy techniques, prior to observation.

For its observation by scanning electron microscopy, the emulsion sample may also be prepared with another initiator, namely AIBN (azobisisobutyronitrile), according to the following protocol:
degassing and stirring of 17.5 mL of nanocrystal suspension at 3 g/L mM, for 10 min. under nitrogen,
addition of 7.5 mL of styrene and 69.8 mg of AIBN,
ultrasound emulsification for 1 min.,
degassing for 10 min., and
polymerization while stirring at 70° C., for 1 hr. to 24 hrs.
   The resulting preparation undergoes a metallization step according to traditional scanning electron microscopy techniques, prior to observation.

### B. Results

### Result 1: Stabilizing an Emulsion Using Bacterial Cellulose Nanoparticles

The bacterial cellulose nanocrystals are produced according to Protocol 1, and consist of neutral particles.

As is shown herein below, these nanocrystals offer excellent properties for forming especially stable Pickering emulsions.

Emulsions of this type have been created according to Protocol 8, for various hexadecane/aqueous phase ratios; namely, ranging from a 5/95 ratio up to a 50/50 ratio.

Therefore, the particle concentration in the emulsions varies along with the water volume fraction in said emulsions.

Optical microscopy analysis according to Protocol 9 yields the results listed in Table 1 below.

TABLE 1

| Sample | | | Average | Average | |
|---|---|---|---|---|---|
| (Hexadecane/ | | Average | Number | Weight | |
| Water | Number of | Area | Diameter | Diameter | Poly- |
| Ratio) | Drops | μm² | μm | μm | dispersity |
| 10-90 | 250 | 6.4 | 3.0 | 3.4 | 1.15 |
| 20-80 | 250 | 7.9 | 3.3 | 3.7 | 1.12 |
| 30-70 | 855 | 13.9 | 4.3 | 4.8 | 1.12 |
| 40-60 | 252 | 18.1 | 4.9 | 5.5 | 1.12 |
| 50-50 | 259 | 24.0 | 5.6 | 6.4 | 1.14 |

The measurements of number of drops, average area, average number diameter, average weight diameter, polydispersity (average weight diameter/average number diameter), and percentage of aggregates were measured as described by Putaux et al. (1999, International Journal of Biological Macromolecules, Vol. 26 (2-3): 145-150) and by Barakat et al. (2007, Biomacromolecules, Vol. 8 (4): 1236-1245).

For these various ratios, approximately the same average diameter is measured by image analysis, namely 4±2 μm with a polydispersity of 1.13±0.2.

The primary difference relates to the rate of aggregation, which decreases along with the decrease in particle quantity per mL of hydrophobic phase.

According to these results, and in order to limit aggregation phenomena, a 30:70 ratio is selected for the following experiments.

The stability of the samples, which are stored under varying conditions (time, temperature), is evaluated according to Protocol 9.

No variation in droplet size was observed, even after keeping samples at 4° C. or 40° C. for one month, or at 80° C. for up to 3 hours.

### Result 2: Characterization of the Cellulose Nanocrystals

The bacterial cellulose nanocrystals produced according to protocols 1 through 5 are characterized by transmission electron microscopy in accordance with Protocol 7.

The nanocrystal surface characteristics and the emulsion's characteristics are determined according to protocols 6 and 9.

The obtained results are summarized in Table 2 below.

TABLE 2

| | | | | | Droplet |
|---|---|---|---|---|---|
| | Length/ | | | | Size (μm) |
| | Thickness in | SD | Charge Density | Charge Number | Dnou |
| Sample | nm | (Sulfate/sugar) | (Sulfate/nm²) | per Nanocrystal | Image J |
| BMCC | 919/17 | 1.96 * 10⁻⁴ | 9.68 * 10⁻⁴ | 42.9 | 4.3 |
| s-wh | 644/17 | 2.41 * 10⁻³ | 1.19 * 10⁻² | 370.7 | 6.8 |
| d-s-wh | 624/12 | 5.92 * 10⁻⁴ | 2.92 * 10⁻³ | 69.8 | 3.4 |
| Cotton t0 | 189/13 | 7.92 * 10⁻³ | 0.123 | 952 | 11.0 |
| Cotton t1h HCl | 157/13 | 2.23 * 10⁻³ | 0.035 | 224 | 6.7 |
| Cotton t2h | 147/13 | 1.21 * 10⁻³ | 0.019 | 114 | 3.2 |
| Cotton t5h | 141/13 | 1.24 * 10⁻³ | 0.019 | 123 | 3.7 |
| Cotton t10h | 117/13 | 1.32 * 10⁻³ | 0.020 | 100 | 5.9 |
| Cotton t10h TFA | 128/13 | 1.08 * 10⁻³ | 0.017 | 89 | 5.3 |

It should be noted that, for Table 2, the charge density may be expressed interchangeably either as e·nm⁻² or sulfate·nm⁻², since the sulfate ion carries a single charge.

The electron microscopy analyses show that all of the particles are elongated in shape.

For all of the cellulose nanocrystals, hydrolysis by sulfuric acid tends to shorten their length. For example, BMCC is shortened from 919 nm to 644 nm, with no noteworthy variation in width after the sulfation step.

Conversely, hydrolysis by hydrochloric acid tends to cause peeling of the surface of the cellulose nanocrystals and therefore to reduce or even eliminate the sulfate groups, and hence reduce or eliminate the corresponding charges.

The corresponding emulsion is very stable (at least one year), and withstands freezing and heating (2 hours at 80° C.).

### Result 3: Influence of Ionic Strength on Emulsion Stability

Emulsions were prepared from cotton cellulose nanocrystals as described in Protocol 8.

For emulsion preparation, an aqueous medium with increasing ionic strength values was used.

More specifically, we used liquid aqueous media with increasing NaCl final concentration values, as listed in Table 3 below.

TABLE 3

| NaCl (M) | Thickness (mm) | Volume % | Zeta Potential (mV) |
|---|---|---|---|
| 0 | 0 | 0 | −55 |
| 0.02 | 9.2 | 42.6 | −35 |
| 0.05 | 9.6 | 44.4 | −25 |
| 0.08 | 9.5 | 44.0 | −10 |
| 0.1 | 9 | 41.9 | ~0 |
| 0.2 | 9.08 | 42.0 | ND* |
| 0.5 | 7.97 | 36.9 | ND |

*ND: Not Determined

The results presented in Table 3 show the evolution of the emulsion's thickness obtained after creaming (centrifugation); this involves a relative value in mm, of an emulsified volume percentage and zeta potential values, which illustrates the screening level of the surface charges by the added NaCl.

### Example 2

### Production of an Oil-in-Water MIPE or HIPE Emulsion

First, we prepare a Pickering emulsion composition stabilized by cellulose nanocrystals with a recovery rate by the cellulose nanocrystals of at least 60%, as described in Example 1.

Second, generally speaking, we add an appropriate quantity of hydrophobic phase for producing a MIPE or HIPE emulsion that has the desired hydrophobic dispersed phase volume/emulsion volume ratio, as is illustrated in detail herein below.

2.1. Production Trial for a Single-Step MIPE or HIPE Emulsion by Forming a Pickering Emulsion Stabilized with Cellulose Nanocrystals, with Decreasing Water/Oil Ratios

### a) First Trial for Direct Production of a MIPE or HIPE Emulsion

In order to determine whether it is possible to produce directly a MIPE or HIPE emulsion by emulsifying a large quantity of oil in a Pickering emulsion produced in accordance with the protocol in Example 1, we prepared 16 emulsions with varying water/hexadecane ratios.

Next, we centrifuged [the emulsions] at 4000 g for 5 min. and, after measuring the thickness of each Pickering emulsion, we calculated the internal phase percentage as described herein below.

### Determining the Internal Phase Percentage

We characterized the emulsions by measuring the supernatant (oil), and the emulsion volume, in order to determine the hydrophobic phase percentage in relation to the total emulsion volume. Therefore, it is the volume of incorporated oil from which the supernatant (nonemulsified) oil is subtracted, divided by the emulsion volume.

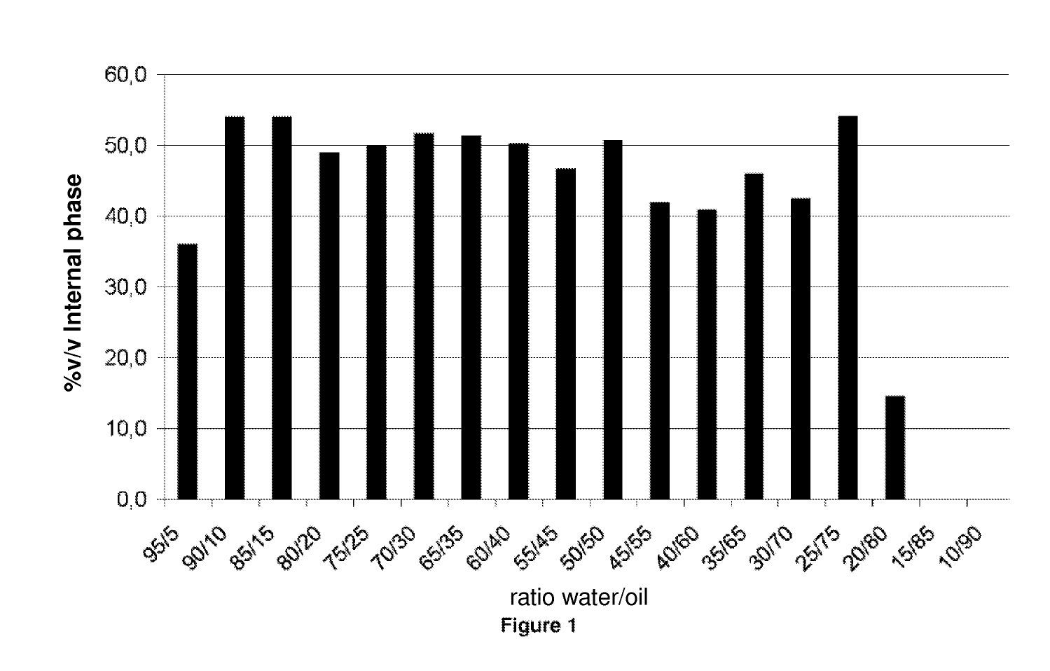

The results are presented in FIG. 1.

The results in FIG. 1 show that the MIPE or HIPE Pickering emulsions thereby produced always have an internal phase percentage that is lower than or equal to 55%.

These results show that it is therefore impossible to produce directly a MIPE or HIPE emulsion, specifically one whose internal phase percentage is higher than 55%, from a suspension of cotton nanocrystals and oil (hydrophobic phase).

### b) Second Trial for Direct Production of a MIPE or HIPE Emulsion Via Centrifugation

We prepared 7 Pickering emulsions with 2 mL hexadecane in 90/10 water/oil proportion in 10 mL tubes.

Next we added, respectively: 4, 5, 6, and 7 mL of hexadecane (listed as 4H, 5H, 6H, and 7H) and 3 and 4 mL of cyclohexane (listed as 3C, 4C). These emulsions were centrifuged at 4000 g for 5 min.

The results are presented in Table 4 below.

TABLE 4

| Tube | 4H | 5H | 6H | 7H | 3C | 4C |
|---|---|---|---|---|---|---|
| % ratio | 75.0 | 74.8 | 74.4 | 74.8 | 74.5 | 75.1 |

The results show that an internal phase percentage in the emulsion that is near the theoretical 74% limit in hydrophobic dispersed phase volume is consistently achieved, but cannot be exceeded even when the centrifugation step is repeated.

In the present trials, it did not prove possible to exceed the maximum level of packing of hydrophobic phase monodisperse spheres, or “close packing,” by directly creating a Pickering emulsion in a single step.

However, these trials did produce emulsions whose internal phase percentage was higher than 55% even at the 74-75% maximum; that is, MIPE-type emulsions.

2.2.—Preparation Trial of a HIPE Emulsion of the Invention, Starting from a Pickering Emulsion Not in Close Packing

We prepared 5 2 mL Pickering emulsions as described above, in 50 mL flasks, and added, respectively, 5, 10, 12.5, 13, and 15 mL of hexadecane.

We created an emulsion by having the obtained mixture undergo a stirring step, using an Ultraturrax™ device, for 1 min. at 27000 g, without centrifugation.

We thereby verified the influence of the emulsion volume and of the container (50 mL Falcon plastic tube).

### 2.3. Preparation of an Oil-in-Water MIPE or HIPE Emulsion of the Invention

We prepared a Pickering emulsion stabilized by cellulose nanocrystals with a recovery rate higher than 60% and with a 30/70 hexadecane/water ratio.

Next, we added 5 mL of hexadecane and emulsified using the Ultraturrax™.

We showed that one may thereafter emulsify any added volume of hydrophobic phase. To do this, we prepared 5 5-mL samples of a Pickering emulsion stabilized with cellulose nanocrystals, then we added, respectively, 0, 5, 7.5, 8, and 10 mL of hexadecane before performing a stirring step with the Ultraturrax™.

We measured the volumes of the various emulsions produced, and calculated the hydrophobic dispersed phase volume/emulsion volume ratio.

The results are presented in Table 5 below.

TABLE 5

| Tube | 5 mL test | 10 mL | 12.5 mL | 13 mL | 15 mL |
|---|---|---|---|---|---|
| Ratio % | 73.8 | 84.0 | 86.6 | 87.1 | 87.9 |

The results of Example 2 show that:
We encounter the same value (74%±1%) in a 50 mL tube as that produced with 10 mL tubes. The container and increase in volume do not modify the produced results.
We were able to produce a MIPE emulsion by adding 5 mL of hexadecane into a Pickering emulsion.
We were able to produce HIPEs for the 4 emulsions ranging from 10 to 15 mL of added hexadecane that had undergone a first Pickering emulsion step.
Additionally, the 4 emulsions ranging from 10 to 15 mL of added hexadecane are all unstable during manual stirring but not the one with 5 added mL. Indeed, vigorous and brief stirring is sufficient for breaking the HIPE emulsion (which turns back into the Pickering emulsion and an oil supernatant). However, this effect is reversible and re-emulsification with the Ultraturrax™ produces a HIPE again.
However, maturation of the emulsion does occur, and after 1 or 2 days, the HIPEs have increased stability properties and are no longer “breakable” through stirring (including the HIPE emulsion having 88% hydrophobic dispersed phase volume).

### Example 3

### Preparation of an Oil-in-Water MIPE or HIPE Emulsion (1)

### General Principle

Several MIPE or HIPE emulsions as described in Example 2 are prepared, again in 50 mL Falcon™ tubes, while varying the types of oils used as the hydrophobic phase and varying the hydrophobic phase volumes added.

We studied, in particular, (i) the stability of MIPE or HIPE emulsions against the external mechanical stresses generated by centrifugation and (ii) the emulsions' structure, using confocal microscopy.

### A. Analysis Protocols

Laser scanning confocal microscopy or LSCM produces an image via fluorescence at the center of a sample by focusing a plane without cutting out the sample ahead of time. Fluorescent markers must therefore be used. We used:
The compound referred to as Bodipy (4,4-difluoro-4-bora-3a,4a-diaza-s-indacene) for the oil phase:
Excited at 546 (green)—Emits in red
Fluorescein for the water phase: Excited at 485 nm (blue)—Emits at 525 nm (green)

Additionally, digitization of several planes that are sufficiently close together may yield a 3D representation of a thin slice of the sample.

### B. Confirmation of Initial Results and Complementary Results

In order to confirm the previous results and to produce additional data, Pickering emulsions are prepared from hexadecane (30/70 hexadecane/water) to which hexadecane (H) or cyclohexane (C) is added, as in Part 2 (from 5 mL to 15 mL). This addition is performed in 2 steps, as specified in Example 2.3, when the volume of added oil is higher than 5 mL. All of the emulsions are stirred, using an Ultraturrax™ device, for a total time period of 1 minute, under the following conditions: stirring for 30 seconds at a stirring force of 11000 rpm, followed by stirring for 30 seconds at a stirring force of 15000 rpm, followed by stirring for 30 seconds at a stirring force of 15000 rpm. 12 emulsions samples are then produced in 50 mL Falcon™ tubes; the tubes have been respectively labeled 5H, 7H, 9H, 11H, 13H, 15H, 5C, 7C, 9C, 11C, 13C, and 15C.

While the hexadecane is being added, and immediately after each hexadecane addition (performed in 2 steps for V_{added}>5 mL, see Example 2, §2.3), the following “measurements” are taken:
stirring time using Ultraturrax™ before apparent “setting” of emulsion
Thickness of oil supernatant
Mass of the mixture, in order to determine the precise volume of added oil
Observation under microscope

Following these measurements, each tube is placed inside a centrifuge, whose rotation speed is gradually increased. We observe the centrifuge speed at which a modification in the macroscopic structure in the MIPE or HIPE emulsion is generated.

Based on the measurements taken, we obtain the following results (calculations are similar to previous ones), which are presented in Table 6 at the end of the present description.

The internal phase percentage results presented in Table 6 are similar to the results produced in Example 2.

Consequently, the method for producing a MIPE or HIPE emulsion described in the examples is highly reproducible.

Table 6 (at the end of the description) also presents the “MINIMUM” internal phase percentage calculation results. The MINIMUM internal phase percentage value is calculated by taking into account all of the lower limits of the measurement reading uncertainties, in order to increase the certainty that MIPE or HIPE emulsions have been generated, and that there was not an initial overestimation of the hydrophobic internal phase percentage value that might be due to measurement uncertainties. We take the lower limit for the quantity of added oil and the supernatant volume (measured with the upper edge of the meniscus). Moreover, we do not take into account the Pickering emulsion's oil volume as the dispersed volume.

In actual practice, the “MINIMUM” percentage values presented in Table 6 are extrapolated because the “MINIMUM” hydrophobic internal phase percentage values are significantly underestimated. Nevertheless, these underestimated values confirm that we did in fact produce MIPE or HIPE emulsions in all cases.

It should be noted that the duration of the stirring step required for mixing the added hydrophobic phase/initial Pickering emulsion increases along with the volume of mixture to be emulsified (see Line 2 of Table 6).

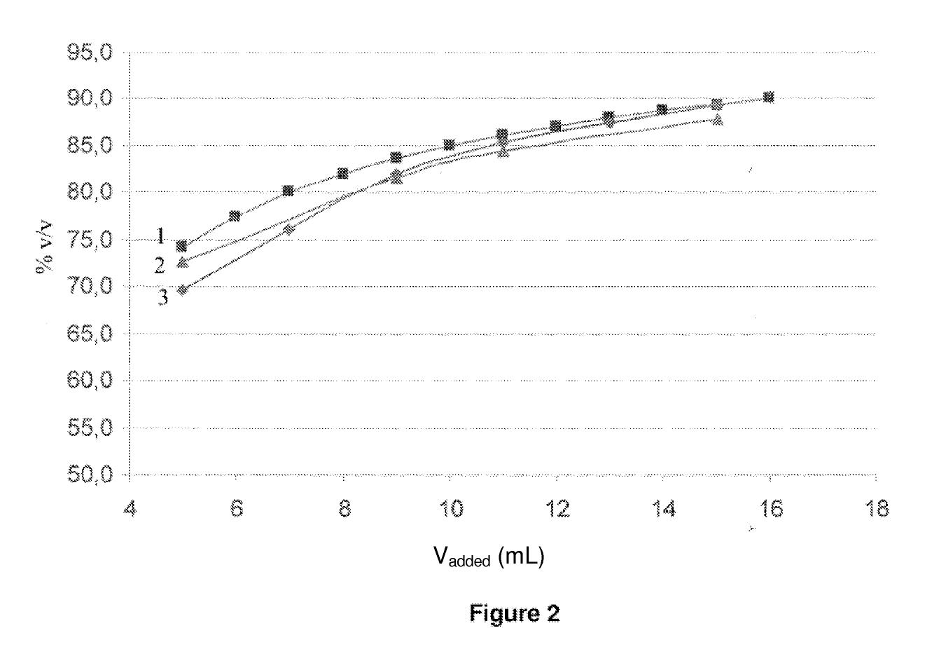

We have also traced, on the graphic in FIG. 2, the theoretical curve (Curve No. 1, if the entirety of the hydrophobic phase is in the form of hydrophobic dispersed phase; that is, if the entire volume of the hydrophobic phase is emulsified) and the experimental curves giving the internal phase percentage based on the added volume (Curve No. 2: cyclohexane hydrophobic phase; Curve No. 3: hexadecane hydrophobic phase).

The results in FIG. 2 show that the experimental curves are nearly identical to the theoretical curve; the differences may result, in particular, from handling uncertainty while preparing each of the two types of MIPE/HIPE emulsion.

The results in FIG. 2 show that the volume of hydrophobic phase that it is necessary to add to the starting Pickering emulsion, in order to produce a final MIPE or HIPE emulsion, having a desired hydrophobic dispersed phase/emulsion volume ratio, may be determined on the basis of the theoretical curve values, regardless of the type of hydrophobic phase used.

By way of illustration, on the basis of either the theoretical curve or of the corresponding experimental curve, we can anticipate that 100 mL of oil must be added to 2 mL of Pickering emulsion in order to produce a HIPE emulsion with an internal phase percentage (or volume of hydrophobic dispersed phase out of emulsion volume) of 98%.

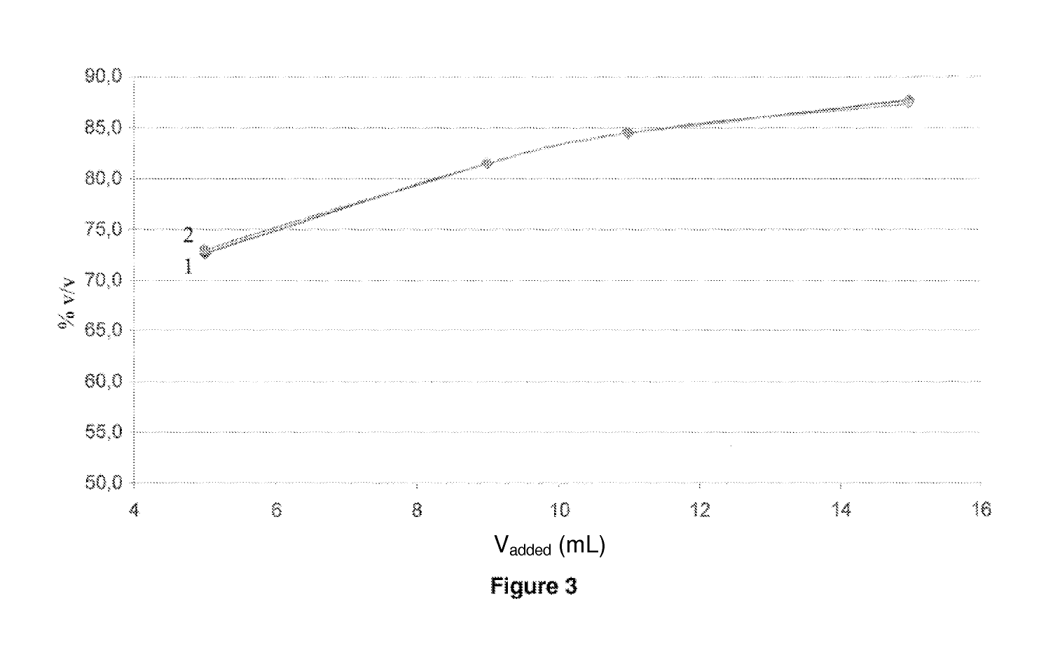

The results of another trial comparing the variation of the dispersed phase percentage based on the emulsion volume, for a hexadecane HIPE emulsion and a cyclohexane HIPE emulsion, respectively, are shown in FIG. 3.

Observation of HIPE emulsions under a microscope has shown a general trend enabling us to advance hypotheses on the mechanism whereby oil drops are stabilized by the beads in the starting Pickering emulsion.

In an initial step, we see that there is a major difference between observing a HIPE that is in relaxed mode versus one that is constrained (without lamella and with lamella). Indeed, when stress is absent, we see a dense structure with well-rounded drops.

When we impose a stress (e.g., by pressing on the lamella), the drops change shape, forming polyhedrons, and thereby the amount of available space for the dispersing phase is minimized.

From this, we conclude that the formed emulsion has a highly resistant viscoelastic interface and that deformation of the droplets may occur without coalescence until polyhedrons are formed.

### Example 4

### Preparation of an Oil-in-Water HIPE Emulsion (2)

4 cyclohexane Pickering emulsions (2 mL at 90/10) are prepared following the protocol in Example 1. Cyclohexane or hexadecane is added to the Pickering emulsions, producing 8 samples contained in tubes labeled 5cH, 9cH, 11cH, 15cH, 5cC, 9cC, 11cC, and 15cC (c for cyclohexane Pickering; H for hexadecane HIPE; and C for cyclohexane HIPE). Since the manipulator for this experiment is different from the one that created the emulsions described in the previous examples, we also prepare two 9H and 9C HIPE emulsions as in the previous examples for interexperimental control purposes. The same analyses are performed as in the previous examples on these 8 emulsions.

After measurements are taken, the same results are produced for 9H and 9C for both manipulators. The results therefore confirm the excellent reproducibility of the method for producing HIPE emulsions of the invention.

For HIPE emulsions prepared from cyclohexane Pickering emulsions, we produced the results presented in Table 7 below.

TABLE 7

| Tube | 5cH | 9cH | 11cH | 15cH | 5cH | 9cH | 11cH | 15cH |
|---|---|---|---|---|---|---|---|---|
| Internal phase | 72.6 | 81.5 | 84.5 | 87.7 | 72.9 | 81.5 | 84.5 | 87.3 |
| % v/v | | | | | | | | |

The results in Table 7 show that nearly the same results are produced for both oils, cyclohexane and hexadecane respectively, just as was the case for a hexadecane Pickering emulsion.

The results show that, in a global sense, HIPEs originating from cyclohexane or hexadecane Pickering emulsions are similar in terms of their internal phase percentages: for both emulsions, the percentage varies in nearly the same way with the added volume.

### Example 5

### Mechanical Stress Resistance Properties of a HIPE Emulsion

The results of tests on resistance to centrifugation of various hexadecane HIPE emulsions are presented in Table 8 below.

TABLE 8

| Tube | Acceleration Interval When |
|---|---|
| (H = hexadecane) | Rupture Occurs (in g) |
| 5H | 16000-20000 |
| 7H | 8000-16000 |
| 9H | 10000-16000 |
| 11H | 10000-16000 |
| 13H | 0-10000 |
| 15H | 0-10000 |

The moment when the emulsion is considered to be “broken” is solely determined by macroscopic appearance.

Beyond the centrifugation rupture force value, the samples are in the form of three highly distinct phases: (i) the first phase, composed of aggregates of cellulose nanocrystals located near or on the wall of the tube; (ii) the second phase, composed of the aqueous phase; and (iii) the third phase, composed of the oil phase, which overlaps with the second phase.

However, if the HIPE emulsion was created by adding a volume less than or equal to 5 mL of oil under the test conditions described in the present example, the HIPE emulsion reforms. In embodiments wherein the volume of added oil is higher than 5 mL, again under the test conditions described in the present example, creating a stirring step involving an Ultraturrax™ device is sufficient to again generate a HIPE emulsion. These results show the total reversibility of the HIPE emulsions of the invention.

### Example 6

### Structural Characteristics of a HIPE Emulsion of the Invention

We carried out a confocal microscopy study in order, first of all, to obtain images at the center of the emulsion. Indeed, the method used for observations made via optical microscopy in the presence or absence of a lamella distorts the observation to some extent (the observed focal plane is always a plane that is very close to the lamella).

We therefore used square-well slides that left a small space between the slide and the lamella while keeping the 4 edges of the interstice sealed.

We thereby preserve, more or less, the existing physical conditions at the center of a HIPE contained in a receptacle such as a Falcon tube, for example.

Confocal microscopy of various hexadecane and cyclohexane Pickering samples, and of the 5H, 9H 13H, 5C, and 14C HIPEs is performed.

Observation of simple Pickering emulsions does not yield any information in addition to microscopic observation. All we see is that the Bodipy hydrophobic phase marker is located near the oil/water interface. We reproduce these results even when a large quantity of Bodipy is used, in this case 0.25 mg for 700 μL of oil for marking the oil in the HIPEs.

We used various types of slides, as indicated above.

When we use a traditional microscope slide or a deep-well slide, we see an emulsion system tightened at the interface with the walls of the lamella (greatest stress). Everywhere else, the drops are well-rounded.

Using a well that marks off edges for the emulsion imitates quite accurately what occurs inside a 50 mL Falcon™ tube (identical observation at the center and on the edge of the lamella).

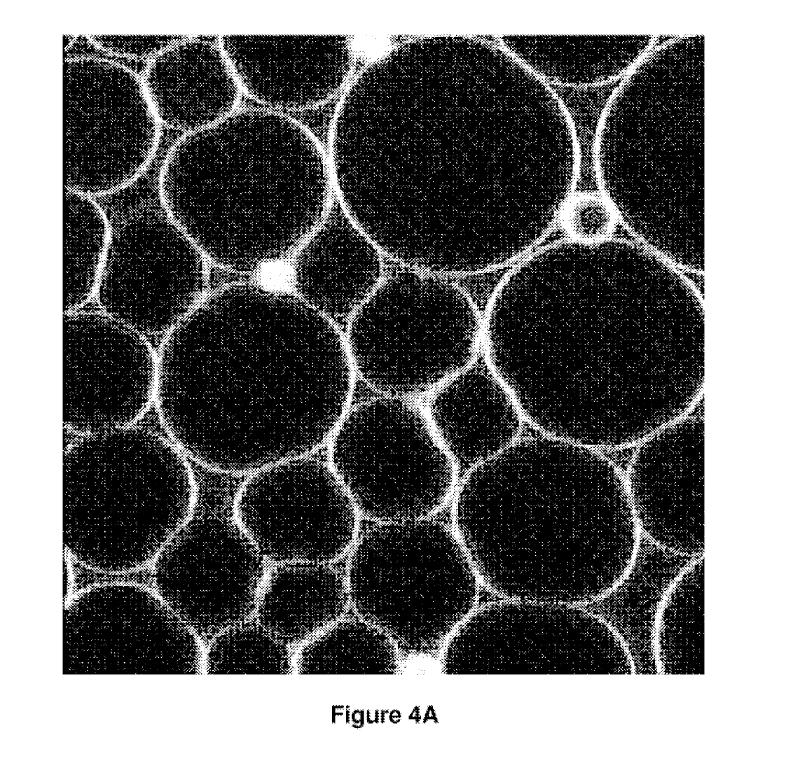

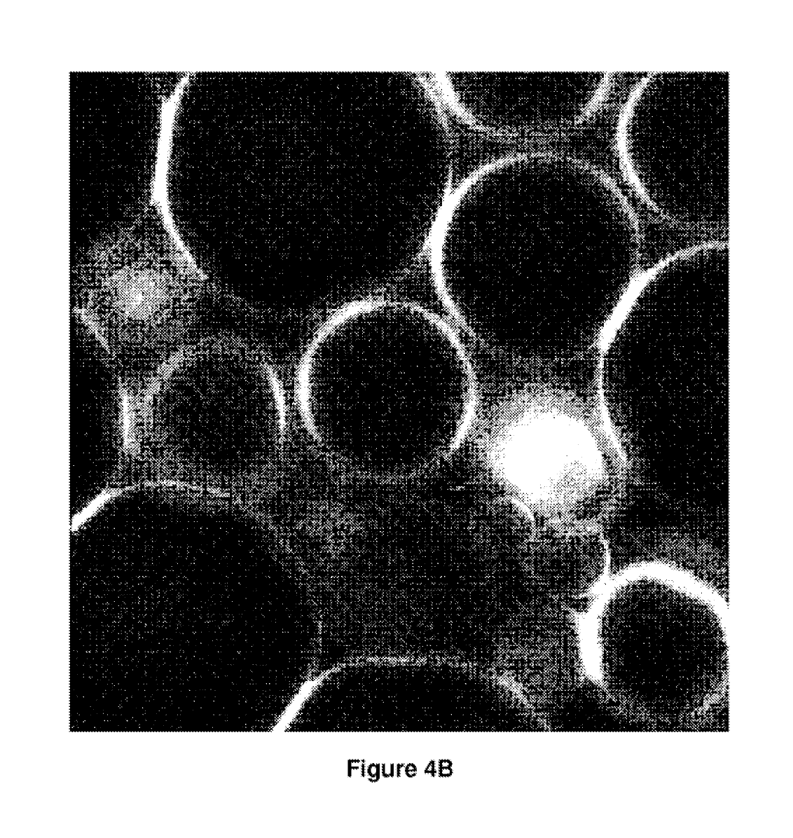

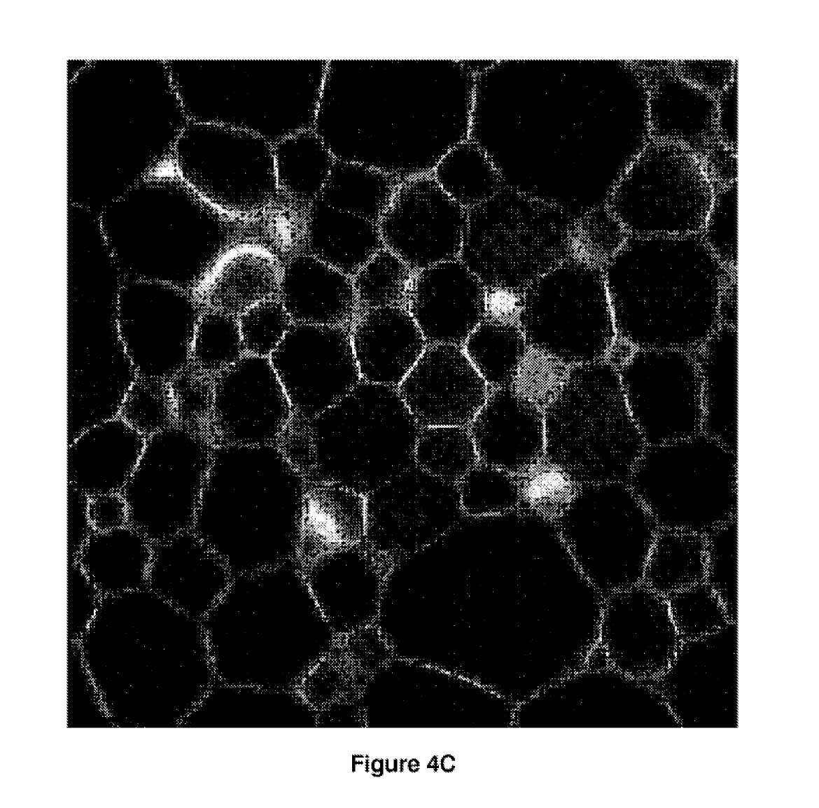

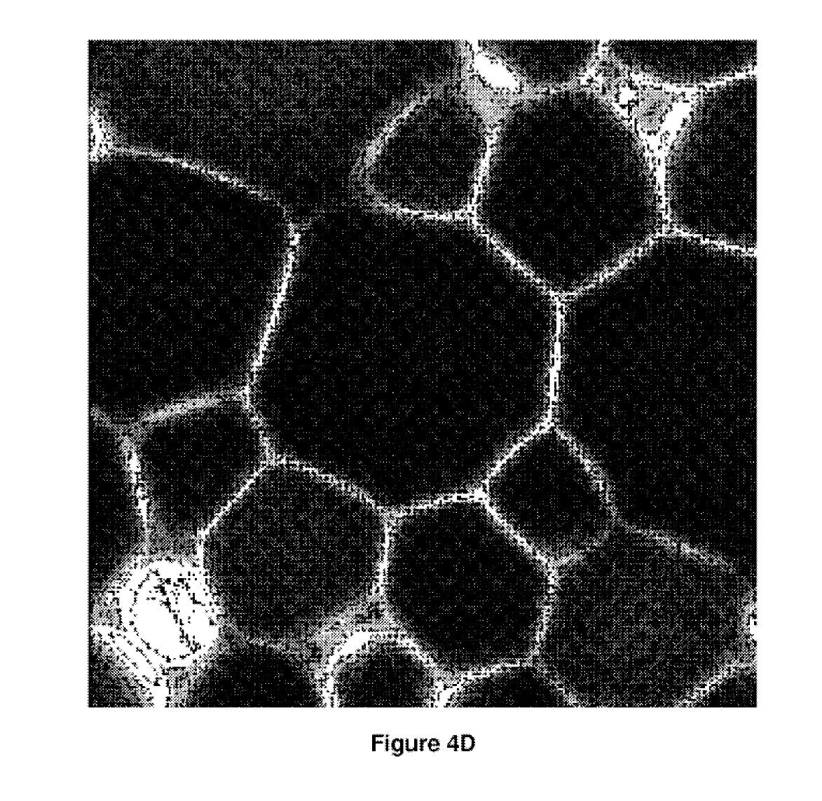

Microphotographs of a starting Pickering emulsion marked with fairly concentrated Bodipy (0.25 mg for 700 μL of oil) are presented in FIGS. 4A and 4B.

Microphotographs of a “13C” HIPE emulsion (87.5 percent of cyclohexane oily internal phase for a 12/88 final water/oil ratio) (stabilized with 1.8 mg of cellulose nanocrystals), marked with fairly concentrated Bodipy (0.25 mg for 700 μL of oil) are presented in FIGS. 4C and 4D.

### Example 7

### Preparation of a Dry Foam Material from a HIPE Emulsion of the Invention

We prepared a Pickering emulsion with cyclohexane. From that, we prepared a cyclohexane HIPE with approximately 87% of internal phase (type 13cC). These two preparations were lyophilized at 0.02 mbar for approximately 12 hrs.

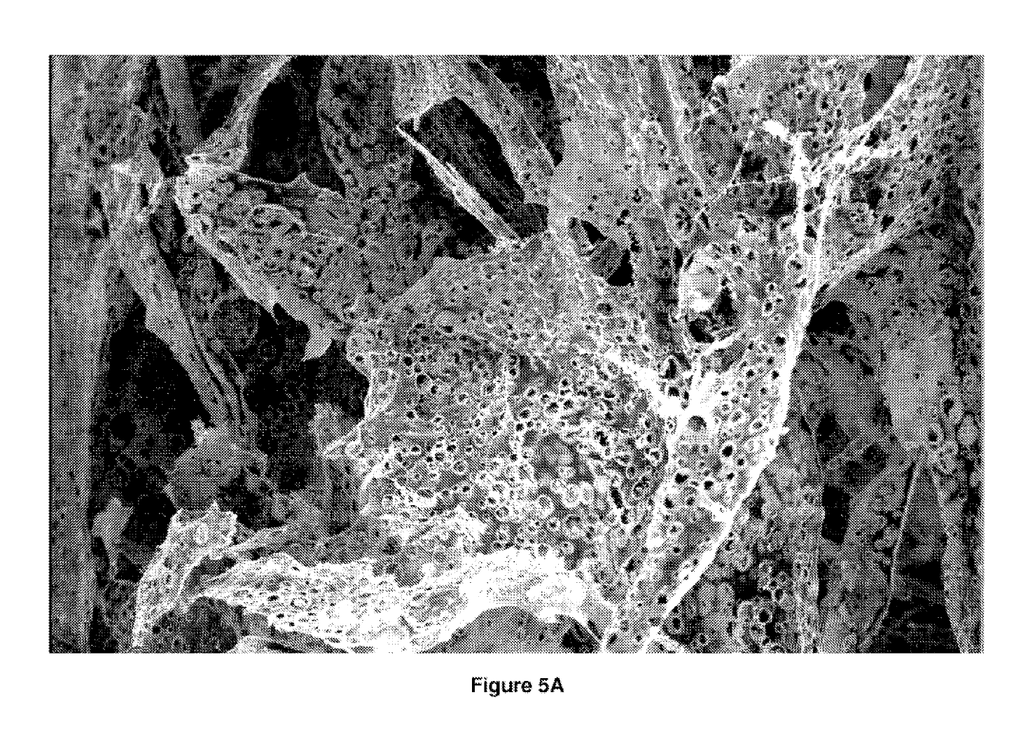

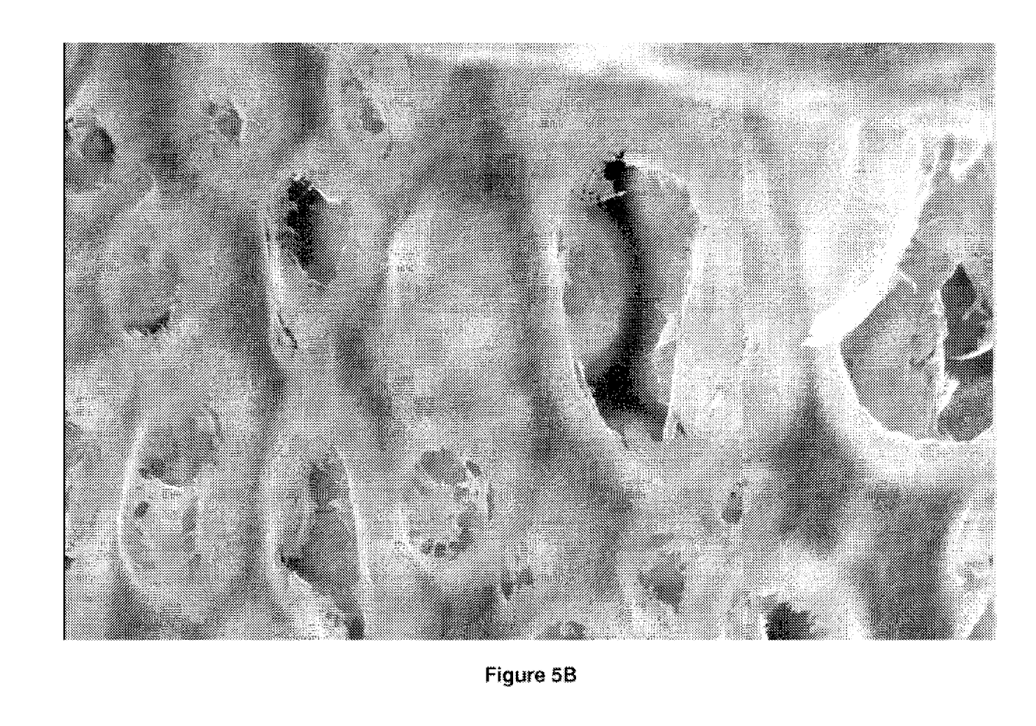

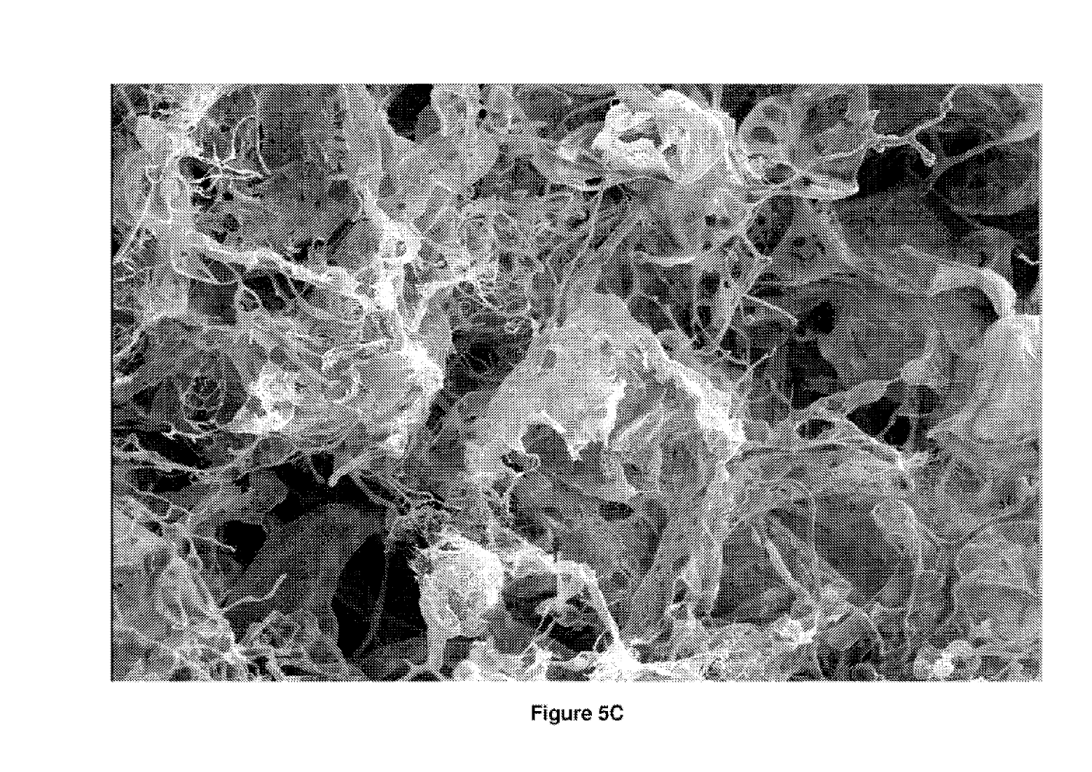

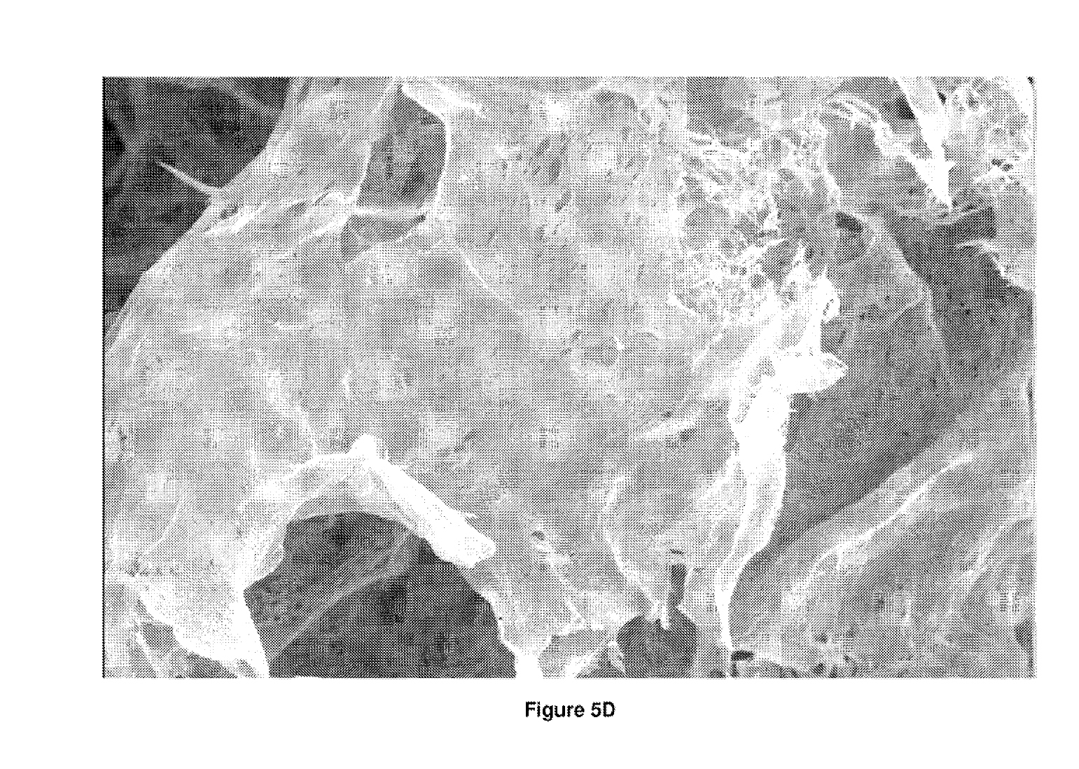

We observed the produced cellulose dry foams using scanning electron microscopy (SEM). The results are shown in FIGS. 5A through 5D.

### Example 8

### Influence of Surface Charge Density and Salinity on Texture of a Gel

We successfully demonstrated textural differences based on the surface charge density present on the cellulose nanocrystals, the nanocrystal concentration in the aqueous phase, and the salt concentration (only NaCl was tested, but this is applicable to other salts).

To do this, suspensions at 3 nanocrystal concentrations (3 g/L, 5 g/L, and 8 g/L) were used; 5 salt concentrations (0.01 M, 0.02 M, 0.05 M; 0.1 M, and 0.2 M) for nanocrystals having two surface charge levels (0.016 e/nm² and 0.16 e/nm²).

The HIPEs were made in two steps: (i) preparation of Pickering emulsions with a 90/10 water/oil ratio, (ii) 3 successive additions of 3 mL of oil while stirring with rotor-stator at between 11000 rpm and 19000 rpm.

After 24 hrs., the texture is then classified according to various categories, ranging from no emulsion to a solid gel.

A visual observation was made in order to determine the flow rate of the emulsion inside a tube when it is moved from a vertical to a horizontal position, in order to distinguish among:

A: no stable emulsion;

B: direct flow, corresponding to an unstructured gel emulsion;

C: delayed flow, corresponding to a liquid gel;

D: quite slow flow, corresponding to a viscous gel;

E: slow flow, corresponding to a viscoelastic gel;

F: no flow, corresponding to a solid gel.

The gel is more structured when:
the salinity is increased,
the nanocrystal concentration is increased,
the surface charge density is decreased.

These results were evaluated via a qualitative test, the observations of which are grouped in the FIG. 6 phase diagrams ranging from absence of emulsion to a solid gel.

The observed textural differences lead us to believe that the nature of the interactions between the nanocrystals at the interfaces are different depending upon the surface charge density carried by these nanocrystals and the presence of salt, leading to interfacial structures of varying rigidity.

For example, a solid gel may be produced for the following combination:
a salt concentration higher than 0.05 M,
a cellulose nanocrystal concentration higher than 8 g/L, and
a surface charge density lower than 0.016 e·nm⁻².

TABLE 6

| Tube | 5H | 7H | 9H | 11H | 13H | 15H | 5C | 7C | 9C | 11C | 13C | 15C |
|---|---|---|---|---|---|---|---|---|---|---|---|---|
| Time before “gel” (dry) | 5 | 10 | 10 | 20 | 20 | 20 | 5 | 5 | 10 | 40 | 40 | 40 |
| v/v internal phase % | 69.7 | 76.0 | 81.9 | 85.4 | 87.3 | 89.3 | 72.0 | 77.8 | 83.42 | 85.85 | 87.5 | 89.41 |
| MINIMUM internal phase % | 59.8 | 69.8 | 77.8 | 82.3 | 84.8 | 87.9 | 61.16 | 70.7 | 80.3 | 83.3 | 84.8 | ND |

ND: Not Determined

1. A method for producing an emulsion including a hydrophobic internal phase dispersed in a hydrophilic continuous phase, having an internal phase percentage higher than 55%, with said method comprising the following steps:
a) producing an oil-in-water emulsion composition with a hydrophobic phase/hydrophilic phase volume ratio of at least 5/95, including a step for incorporating cellulose nanocrystals into the hydrophilic phase, and a step for forming the emulsion by dispersing the hydrophobic phase in the hydrophilic phase,
b) producing the emulsion having an internal phase percentage higher than 55%, including:
b.1) a step for adding a volume of hydrophobic phase to the emulsion composition produced in Step a), and stirring the mixture thereby produced, and/or
b.2) a step for concentrating the emulsion composition produced in Step a), by removing at least part of the hydrophilic phase.

2. The method as claimed in claim 1 wherein, following Step b), the emulsion produced is a medium internal phase emulsion (MIPE) having an internal phase percentage ranging from 55% to 75%.

3. The method as claimed in claim 2 wherein, following Step b), the emulsion produced is a high internal phase emulsion (HIPE) having an internal phase percentage higher than 75%.

4. The method as claimed in claim 1 wherein, in Step a), the emulsion composition has an internal phase percentage that is lower than or equal to 55%.

5. The method as claimed in claim 1 wherein, in Step a), the emulsion composition has a hydrophobic phase/hydrophilic phase volume ratio of at most 60/40.

6. The method as claimed in claim 1 wherein the emulsion prepared in Step b) includes a hydrophobic internal phase/hydrophilic continuous phase volume ratio of at least 80/20.

7. The method as claimed in claim 1 wherein the hydrophobic phase includes a hydrophobic liquid or a mixture of hydrophobic liquids.

8. The method as claimed in claim 7, wherein the hydrophobic liquid is selected from a linear alkane, a branched alkane, a cyclic alkane or a mixture thereof wherein the alkane has a number of carbon atoms ranging from 5 to 18 carbon atoms.

9. The method as claimed in claim 8, wherein the alkane is selected from hexadecane or cyclohexane.

10. The method as claimed in claim 7, wherein the hydrophobic liquid is selected from an edible oil or a mixture thereof.

11. The method as claimed in claim 1, wherein the hydrophilic phase includes a hydrophilic monomer, or a mixture of hydrophilic monomers.

12. An emulsion composition including a hydrophobic internal phase dispersed in a hydrophilic continuous phase, wherein the composition includes cellulose nanocrystals located at the interface between the hydrophobic internal phase and the hydrophilic phase, and wherein the composition has an internal phase percentage higher than 55%.

13. The emulsion composition as claimed in claim 12, wherein the composition has an internal phase percentage higher than 75%.

14. The emulsion composition as claimed in claim 12, wherein the composition has a hydrophobic internal phase/hydrophilic continuous phase volume ratio higher than 70/30.

15. A product of an emulsion composition as claimed in claim 12, selected from a dry emulsion, a dry foam, a porous polymer material, or beads made of polymer material.

16. The method as claimed in claim 7, wherein the hydrophobic liquid is selected from soybean oil, sunflower or mixtures thereof.

17. The emulsion composition as claimed in claim 13, wherein the composition has a hydrophobic internal phase/hydrophilic continuous phase volume ratio higher than 70/30.
